(19) United States
(12) Patent Application Publication
(10) Pub. No.: US 2024/0357187 A1
(43) Pub. Date: Oct. 24, 2024

(54) SERVER AND METHOD

(71) Applicant: 17LIVE Japan Inc., Tokyo (JP)

(72) Inventor: Ayako YANASE, Tokyo (JP)

(21) Appl. No.: 18/511,506

(22) Filed: Nov. 16, 2023

(30) Foreign Application Priority Data
Apr. 24, 2023 (JP) 2023-070727
Jul. 28, 2023 (JP) 2023-123651

(51) Int. Cl. H04N 21/2343; H04N 21/2187; H04N 21/239; H04N 21/482

(52) U.S. Cl. CPC H04N 21/234336; H04N 21/2187; H04N 21/2393; H04N 21/4828

(57) ABSTRACT

A server includes a circuitry, wherein the circuitry is configured to: hold information about a livestreamer distributing a video on a video livestreaming platform; hold video data of the video; convert the video data into text data; use machine learning models each of which is designed to receive the text data and the information about the livestreamer and output a sentence introducing the livestreamer, the machine learning models being respectively configured with different personalities; hold, in a sentence holding unit, an ID identifying the livestreamer, sentences introducing the livestreamer, and output from the machine learning models; receive a search request from a user terminal of a user of the video livestreaming platform; perform a search through the sentence holding unit based on the search request; and provide the user terminal with a result of the search.

### CROSS-REFERENCE TO RELATED APPLICATIONS

This application is based on and claims the benefit of priority from Japanese Patent Applications Serial Nos. 2023-070727 (filed on Apr. 24, 2023) and 2023-123651 (filed on Jul. 28, 2023), the contents of which are hereby incorporated by reference in its entirety.

### TECHNICAL FIELD

The present disclosure relates to a server and a method.

### BACKGROUND

With the development of IT technology, the way information is exchanged has changed. In the Showa period (1926-1989), one-way information communication via newspapers and television was the main stream. In the Heisei period (1990-2019), with the widespread availability of cell phones and personal computers, and the significant improvement in Internet communication speed, instantaneous interactive communication services such as chat services emerged, and on-demand video streaming services also became popular as storage costs were reduced.

And nowadays or in the Reiwa period (2019 to present), with the sophistication of smartphones and further improvements in network speed as typified by 5G, services that enable real-time communication through video, especially livestreaming services, are gaining recognition. The number of users of livestreaming services is expanding, especially among young people, as such services allow people to share the same good time even when they are in the separate locations from each other.

In livestreaming platforms, livestreamers can start a livestream whenever they want and viewers can watch livestreams of their interest whenever they want. Japanese Translation of PCT International Patent Application No. 2020-521207 discloses a technique for recommending livestreaming contents using machine learning.

Information about livestreamers includes a wide variety of data, such as livestreaming video data (images and audio), the livestreamers' profile, data indicating who follows the livestreamers and who the livestreamers follow, comment histories, viewing histories, and tags. If such a wide variety of data can be all used to search for livestreamers, the search can return more accurate results. In addition, information about livestreams and livestreamers includes a lot of images such as profile images, avatar images and videos. If such images can be used to search for livestreams or livestreamers, the search for the livestream or livestreamer can return more accurate results.

### SUMMARY

In view of above, one object of the disclosure is to provide a technology that can improve searches for videos or livestreamers distributing those videos.

One aspect of the disclosure relates to a server. The server includes a circuitry, wherein the circuitry is configured to: hold, in a livestreamer information holding unit, information about a livestreamer distributing a video on a video livestreaming platform; hold, in a video data holding unit, video data including images and audio of the video distributed by the livestreamer; convert, in a converting unit, the video data held in the video data holding unit into text data; use a plurality of machine learning models each of which is designed to receive the text data and the information about the livestreamer held in the livestreamer information holding unit and output a sentence introducing the livestreamer, the machine learning models being respectively configured with different personalities; hold, in a sentence holding unit, an ID identifying the livestreamer and a plurality of sentences introducing the livestreamer and output from the machine learning models, in association with each other; receive, in a request receiving unit, a search request via a network from a user terminal of a user of the video livestreaming platform; perform, in a search unit, a search through the sentence holding unit based on the search request; and provide, in a providing unit, via the network the user terminal with a result of the search performed by the search unit.

One aspect of the disclosure relates to a server. The server includes a circuitry, wherein the circuitry is configured to: hold, in an image holding unit, images related to a video distributed on a video livestreaming platform; receive, in a request receiving unit, a search request from a user terminal of a user of the video livestreaming platform over a network; acquire, in a generated image acquiring unit, a generated image generated by a machine learning model based on information input into the machine learning model, the information being input by the user and included in the search request; perform, in a search unit, an image search through the image holding unit based on the generated image; and provide, in a providing unit, via the network the user terminal with a result of the image search performed by the search unit.

Another aspect of the disclosure relates to a non-transitory computer-readable storage medium storing a computer program. The computer program causes a terminal to perform functions of: displaying on a display a search criteria receiving screen for enabling an input of search criteria; displaying on the display a generated image display screen including a plurality of generated images generated by a machine learning model based on the search criteria input thereto, the search criteria being input via the search criteria receiving screen; receiving a selection on the generated image display screen, the selection indicating at least one generated image from among the generated images; and displaying on the display an image search result display screen including a result of an image search corresponding to the selection.

It should be noted that the components described throughout this disclosure may be interchanged or combined. The components, features, and expressions described above may be replaced by devices, methods, systems, computer programs, recording media containing computer programs, etc. Any such modifications are intended to be included within the spirit and scope of the present disclosure.

### Advantageous Effects

The present disclosure can improve searches for videos and livestreamers distributing the videos.

### BRIEF DESCRIPTION OF THE DRAWINGS

FIG. 1 schematically illustrates a configuration of a livestreaming system according to a first embodiment.

FIG. 2 is a block diagram showing functions and configuration of a user terminal of FIG. 1.

FIG. 3 is a block diagram showing functions and configuration of a server shown in FIG. 1.

FIG. 4 is a data structure diagram showing an example of a stream DB shown in FIG. 3.

FIG. 5 is a data structure diagram showing an example of a user DB shown in FIG. 3.

FIG. 6 is a data structure diagram showing an example of a gift DB shown in FIG. 3.

FIG. 7 is a data structure diagram showing an example of a personality setting DB in FIG. 3.

FIG. 8 is a data structure diagram showing an example of an introduction DB in FIG. 3.

FIG. 9 is a flowchart showing a series of steps related to a search for a livestreamer performed by a server.

FIG. 10 is a representative screen image of a search receiving screen displayed on the display of an active user's user terminal.

FIG. 11 is a representative screen image of a search result screen displayed on the display of the active user's user terminal.

FIG. 12 is a block diagram showing an example of a hardware configuration of an information processing device.

FIG. 13 is a block diagram showing functions and configuration of a user terminal included in a livestreaming system relating to a second embodiment.

FIG. 14 is a block diagram showing functions and configuration of a server included in the livestreaming system.

FIG. 15 is a data structure diagram showing an example of a stream DB shown in FIG. 14.

FIG. 16 is a data structure diagram showing an example of a user DB shown in FIG. 14.

FIG. 17 is a data structure diagram showing an example of a gift DB shown in FIG. 14.

FIG. 18 is a flowchart showing a series of steps related to a search for a livestreamer performed by the server.

FIG. 19 is a representative screen image of a search criteria receiving screen displayed on the display of the active user's user terminal.

FIG. 20 is a representative screen image of a generated image display screen displayed on the display of an active user's user terminal.

FIG. 21 is a representative screen image of an image search result display screen displayed on the display of the active user's user terminal.

### DESCRIPTION OF THE PREFERRED EMBODIMENTS

Like elements, components, processes, and signals throughout the figures are labeled with same or similar designations and numbering, and the description for the like elements will not be hereunder repeated. For purposes of clarity and brevity, some of the components that are less related and thus not described are not shown in the figures.

### First Embodiment

In a livestreaming system relating to a first embodiment, data of livestreams delivered by livestreamers and information about the livestreamers are input into generative machine learning models such as Generative Pre-trained Transformers (GPTs). The machine learning models output sentences that introduce the livestreamers (hereafter referred to as the introductions). The machine learning models are configured with personalities. With different personalities, the machine learning models are configured to output different introductions for the same input. The livestreaming system uses the generated introductions in searches for livestreamers.

Information pertaining to a livestreamer includes image and audio data of livestreams, comments, gifts, tags indicating the contents, the livestreamer's profile, followers and other various data. The livestreaming system relating to the first embodiment of the present invention summarizes these pieces of information into an introduction and uses the introduction in searches. Thus, the present embodiment can perform searches more efficiently and accurately. Furthermore, since the machine learning models configured with different personalities generate different introductions, the livestreaming system can return search results that fit the user's mood and preferences.

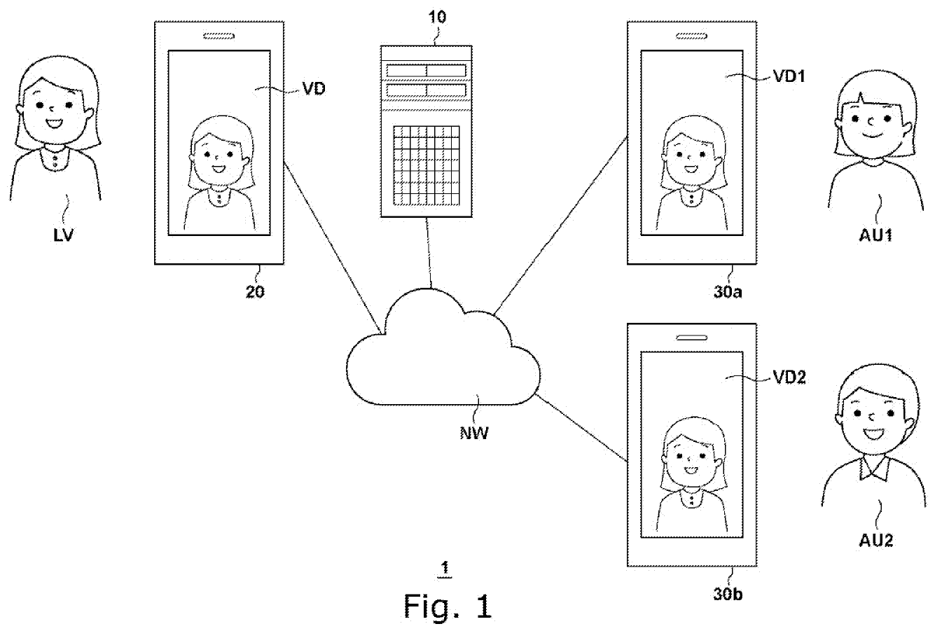

FIG. 1 schematically illustrates the configuration of a livestreaming system 1 according one embodiment of the disclosure. The livestreaming system 1 provides an interactive livestreaming service that allows a livestreamer LV (also referred to as a liver or streamer) and a viewer AU (also referred to as audience) (AU1, AU2, . . . ) to communicate in real time. As shown in FIG. 1, the livestreaming system 1 includes a server 10, a user terminal 20 on the livestreamer side, and user terminals 30 (30a, 30b, . . . ) on the audience side. In addition to the livestreamer who is livestreaming and the viewers who watch the livestream, there may be users who have logged in the livestreaming platform but is neither livestreaming nor watching the livestream. Such users are herein referred to as active users. The livestreamer, the viewers, and the active users may be collectively referred to as users. The server 10 may be one or more information processing devices connected to a network NW. The user terminals 20 and 30 may be, for example, mobile terminal devices such as smartphones, tablets, laptop PCs, recorders, portable gaming devices, and wearable devices, or may be stationary devices such as desktop PCs. The server 10, the user terminal 20, and the user terminals 30 are interconnected so as to be able to communicate with each other over the various wired or wireless network NW.

The livestreaming system 1 involves the livestreamer LV, the viewers AU, and an administrator (not shown) who manages the server 10. The livestreamer LV is a person who broadcasts contents in real time by recording the contents with his/her user terminal 20 and uploading them directly to the server 10. Examples of the contents may include the livestreamer's own songs, talks, performances, fortune-telling, gameplays, and any other contents. The administrator provides a platform for livestreaming contents on the server 10, and also mediates or manages real-time interactions between the livestreamer LV and the viewers AU. The viewers AU access the platform at their user terminals 30 to select and view a desired content. During livestreaming of the selected content, the viewer AU performs operations to comment, cheer, or ask fortune-telling via the user terminal 30, the livestreamer LV who is delivering the content responds to such a comment, cheer, or request and such response is transmitted to the viewer AU via video and/or audio, thereby establishing an interactive communication.

As used herein, the term “livestreaming” or “livestream” may mean a mode of data transmission that allows a content recorded at the user terminal 20 of the livestreamer LV to be played and viewed at the user terminals 30 of the viewers AU substantially in real time, or it may mean a live broadcast realized by such a mode of transmission. The livestreaming may be achieved using existing livestreaming technologies such as HTTP Live Streaming, Common Media Application Format, Web Real-Time Communications, Real-Time Messaging Protocol and MPEG DASH. The livestreaming includes a transmission mode in which, while the livestreamer LV is recording contents, the viewers AU can view the contents with a certain delay. The delay is acceptable as long as interaction between the livestreamer LV and the viewers AU can be at least established. Note that the livestreaming is distinguished from so-called on-demand type transmission, in which contents are entirely recorded and the entire data is once stored on the server, and the server provides users with the data at any subsequent time upon request from the users.

The term “video data” herein refers to data that includes image data (also referred to as moving image data) generated using an image capturing function of the user terminals 20 and 30 and audio data generated using an audio input function of the user terminals 20 and 30. Video data is played back on the user terminals 20 and 30, so that the users can view contents. In this embodiment, it is assumed that between video data generation at the livestreamer's user terminal and video data reproduction at the viewer's user terminal, processing is performed onto the video data to change its format, size, or specifications of the data, such as compression, decompression, encoding, decoding, or transcoding. However, such processing does not substantially change the content (e.g., video images and audios) represented by the video data, so that the video data after such processing is herein described as the same as the video data before such processing. In other words, when video data is generated at the livestreamer's user terminal and then played back at the viewer's user terminal via the server 10, the video data generated at the livestreamer's user terminal, the video data that passes through the server 10, and the video data received and reproduced at the viewer's user terminal are all the same video data.

As used herein, “livestream duration” is a parameter associated with a single livestream and refers to the length of time during which the livestream continues. The livestream duration is calculated irrespective of whether or not there are any viewers of the livestream. As used herein, “total livestreaming time” is a parameter associated with a livestreamer and is obtained by adding up the durations of livestreams performed by the livestreamer in a given period of time.

In the example in FIG. 1, the livestreamer LV is livestreaming his/her talk. The user terminal 20 of the livestreamer LV generates video data by recording images and sounds of the livestreamer LV who is talking, and the generated data is transmitted to the server 10 over the network NW. At the same time, the user terminal 20 displays the recorded video image VD of the livestreamer LV on the display of the user terminal 20 to allow the livestreamer LV to check what is to be streamed.

The user terminals 30a and 30b of the viewers AU1 and AU2 respectively, who have requested the platform to enable them to view the livestream of the livestreamer LV, receive video data related to the livestream over the network NW and reproduce the received video data, to display video images VD1 and VD2 on the displays and output audio through the speakers. The video images VD1 and VD2 displayed at the user terminals 30a and 30b, respectively, are substantially the same as the video image VD captured by the user terminal 20 of the livestreamer LV, and the audio outputted at the user terminals 30a and 30b is substantially the same as the audio recorded by the user terminal 20 of the livestreamer LV.

Recording of the images and sounds at the user terminal 20 of the livestreamer LV and reproduction of the video data at the user terminals 30a and 30b of the viewers AU1 and AU2 are performed substantially simultaneously. The viewer AU1 may type a comment about the talk of the livestreamer LV on the user terminal 30a, and the server 10 may display the comment on the user terminal 20 of the livestreamer LV in real time and also display the comment on the user terminals 30a and 30b of the viewers AU1 and AU2, respectively. The livestreamer LV may read the comment and develop his/her talk to cover and respond to the comment, and the video and sound of the talk are output on the user terminals 30a and 30b of the viewers AU1 and AU2, respectively. This interactive action is recognized as establishment of a conversation between the livestreamer LV and the viewer AU1. In this way, the livestreaming system 1 realizes the livestreaming that enables the interactive communication, not one-way communication.

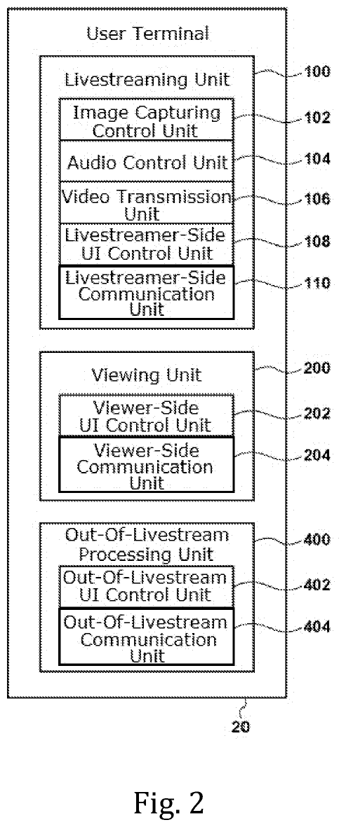

FIG. 2 is a block diagram showing functions and configuration of the user terminal 20 of FIG. 1. The user terminals 30 have the same functions and configuration as the user terminal 20. The blocks in FIG. 2 and the subsequent block diagrams may be realized by elements such as a computer CPU or a mechanical device in terms of hardware, and can be realized by a computer program or the like in terms of software. The blocks shown in the drawings are, however, functional blocks realized by cooperative operation between hardware and software. Therefore, it is understood by those skilled in the art that these functional blocks can be realized in various forms by combining hardware and software.

The livestreamer LV and the viewers AU download and install a livestreaming application program (hereinafter referred to as a livestreaming application), onto the user terminals 20 and 30 from a download site over the network NW. Alternatively, the livestreaming application may be pre-installed on the user terminals 20 and 30. When the livestreaming application is executed on the user terminals 20 and 30, the user terminals 20 and 30 communicate with the server 10 over the network NW to implement various functions. Hereinafter, the functions implemented by (processors such as CPUs of) the user terminals 20 and 30 by running the livestreaming application will be described as functions of the user terminals 20 and 30. These functions are realized in practice by the livestreaming application on the user terminals 20 and 30. In any other embodiments, these functions may be realized by a computer program that is written in a programming language such as HTML (HyperText Markup Language), transmitted from the server 10 to web browsers of the user terminals 20 and 30 over the network NW, and executed by the web browsers.

The user terminal 20 includes a livestreaming unit 100 for recording the user's image and sound to generate and provide video data to the server 10, a viewing unit 200 for acquiring and reproducing the video data from the server 10, and an out-of-livestream processing unit 400 for processing requests made by active users. The user activates the livestreaming unit 100 to livestream, the viewing unit 200 to view a livestream, and the out-of-livestream processing unit 400 to look for a livestream, view a livestreamer's profile, or watch an archive. The user terminal having the livestreaming unit 100 activated is the livestreamer's terminal, i.e., the user terminal that generates video data, the user terminal having the viewing unit 200 activated is the viewer's terminal, i.e., the user terminal that reproduces video data, and the user terminal having the out-of-livestream processing unit 400 activated is the active user's terminal.

The livestreaming unit 100 includes an image capturing control unit 102, an audio control unit 104, a video transmission unit 106, a livestreamer-side UI control unit 108, and a livestreamer-side communication unit 110. The image capturing control unit 102 is connected to a camera (not shown in FIG. 2) and controls image capturing performed by the camera. The image capturing control unit 102 obtains image data from the camera. The audio control unit 104 is connected to a microphone (not shown in FIG. 2) and controls audio input from the microphone. The audio control unit 104 obtains audio data through the microphone. The video transmission unit 106 transmits video data including the image data obtained by the image capturing control unit 102 and the audio data obtained by the audio control unit 104 to the server 10 over the network NW. The video data is transmitted by the video transmission unit 106 in real time. That is, the generation of the video data by the image capturing control unit 102 and the audio control unit 104, and the transmission of the generated video data by the video transmission unit 106 are performed substantially at the same time.

The livestreamer-side UI control unit 108 controls a UI for the livestreamer. The livestreamer-side UI control unit 108 is connected to a display (not shown in FIG. 2), and displays a video on the display by reproducing the video data that is to be transmitted by the video transmission unit 106. The livestreamer-side UI control unit 108 is also connected to input means (not shown in FIG. 2) such as touch panels, keyboards, and displays, and obtains the livestreamer's input via the input means. The livestreamer-side UI control unit 108 superimposes a predetermined frame image on the video image. The frame image includes various user interface objects (hereinafter simply referred to as “objects”) for receiving inputs from the livestreamer, comments entered by the viewers, and information obtained from the server 10. The livestreamer-side UI control unit 108 receives, for example, the livestreamer's inputs made by the livestreamer tapping the objects.

The livestreamer-side communication unit 110 controls communication with the server 10 during a livestream. The livestreamer-side communication unit 110 transmits the content of the livestreamer's input that has been obtained by the livestreamer-side UI control unit 108 to the server 10 over the network NW. The livestreamer-side communication unit 110 receives various information associated with the livestream from the server 10 over the network NW.

The viewing unit 200 includes a viewer-side UI control unit 202 and a viewer-side communication unit 204. The viewer-side communication unit 204 controls communication with the server 10 during a livestream. The viewer-side communication unit 204 receives, from the server 10 over the network NW, video data related to the livestream in which the livestreamer and the viewer participate.

The viewer-side UI control unit 202 controls the UI for the viewer. The viewer-side UI control unit 202 is connected to a display and a speaker (not shown in FIG. 2), and reproduces the received video data so that video images are displayed on the display and sounds are output through the speaker. The state where the images and sounds are respectively output through the display and speaker can be referred to as “the video data is reproduced”. The viewer-side UI control unit 202 is also connected to input means (not shown in FIG. 2) such as touch panels, keyboards, and displays, and obtains viewer's input via the input means. The viewer-side UI control unit 202 superimposes a predetermined frame image on an image generated from the video data obtained from the server 10. The frame image includes various objects for receiving inputs from the viewer, comments entered by the viewer, and information obtained from the server 10. The viewer-side communication unit 204 transmits the content of the viewer's input that has been obtained by the viewer-side UI control unit 202 to the server 10 over the network NW.

The out-of-livestream processing unit 400 includes an out-of-livestream UI control unit 402 and an out-of-livestream communication unit 404. The out-of-livestream UI control unit 402 controls a UI for the active user. For example, the out-of-livestream UI control unit 402 generates a livestream selection screen and shows the screen on the display. The livestream selection screen presents a list of livestreams to which the active user is currently invited to participate to allow the active user to select a live stream. The out-of-livestream UI control unit 402 generates a profile screen for any user and shows the screen on the display. The out-of-livestream UI control unit 402 generates a search screen for receiving a search keyword to be used in a search for a livestreamer and shows the screen on the display. The out-of-livestream UI control unit 402 generates a search result display screen including results of the search for the livestreamer and shows the screen on the display. The out-of-livestream UI control unit 402 plays back an archived past livestream, which is recorded and stored.

The out-of-livestream communication unit 404 controls communication with the server 10 that takes place outside a livestream. The out-of-livestream communication unit 404 receives, from the server 10 over the network NW, information necessary to generate the livestream selection screen, results of searches for livestreamers, information necessary to generate the profile screen, and archived data. The out-of-livestream communication unit 404 transmits the content of the active user's input to the server 10 over the network NW.

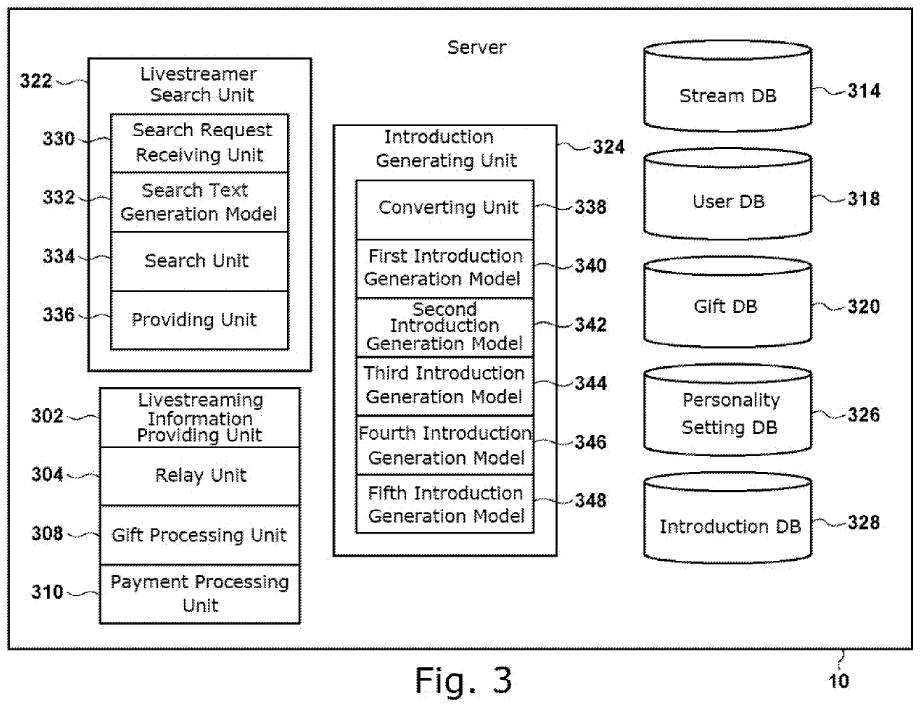

FIG. 3 is a block diagram showing functions and configuration of the server 10 of FIG. 1. The server 10 comprises a circuitry that includes a livestreaming information providing unit 302, a relay unit 304, a gift processing unit 308, a payment processing unit 310, a stream DB 314, a user DB 318, a gift DB 320, a livestreamer search unit 322, an introduction generating unit 324, a personality setting DB 326, and an introduction DB 328.

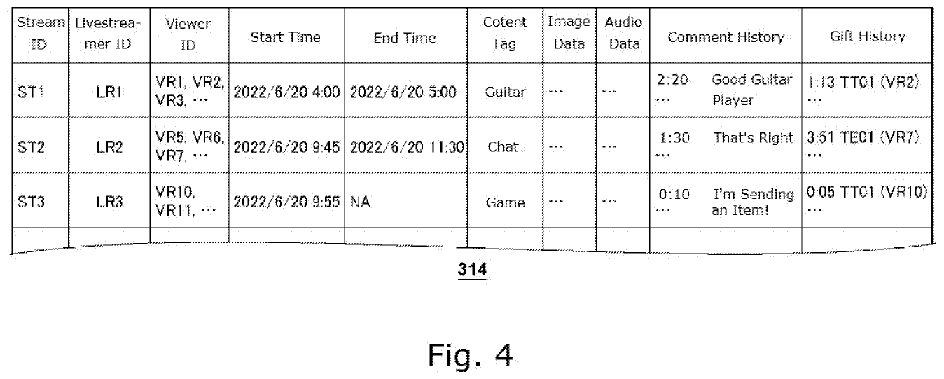

FIG. 4 is a data structure diagram showing an example of the stream DB 314 of FIG. 3. The stream DB 314, or a video data holding unit, holds information regarding livestreams currently taking place and information regarding livestreams that have taken place in the past (archived livestreams). Specifically, the stream DB 314 holds video data including images and audio of videos livestreamed by livestreamers. The stream DB 314 stores a stream ID identifying a livestream on the livestreaming platform provided by the livestreaming system 1, a livestreamer ID, which is a user ID identifying the livestreamer who delivers the livestream, a viewer ID, which is a user ID identifying a viewer of the livestream, a time at which the livestream starts, a time at which the livestream ends (if the livestream is archived), a livestream content tag representing the contents of the livestream, image data of the livestream, audio data of the livestream, a history of comments posted during the livestream, and a history of gifts used in the livestream, in association with each other.

In the livestreaming platform provided by the livestreaming system 1 of the embodiment, when a user livestreams, the user is referred to as a livestreamer, and when the same user views a livestream streamed by another user, the user is referred to as a viewer. Therefore, the distinction between a livestreamer and a viewer is not fixed, and a user ID registered as a livestreamer ID at one time may be registered as a viewer ID at another time.

The content tag of a livestream may be designated by the livestreamer when starting the livestream or obtained from real-time analysis of the livestream by a machine learning model.

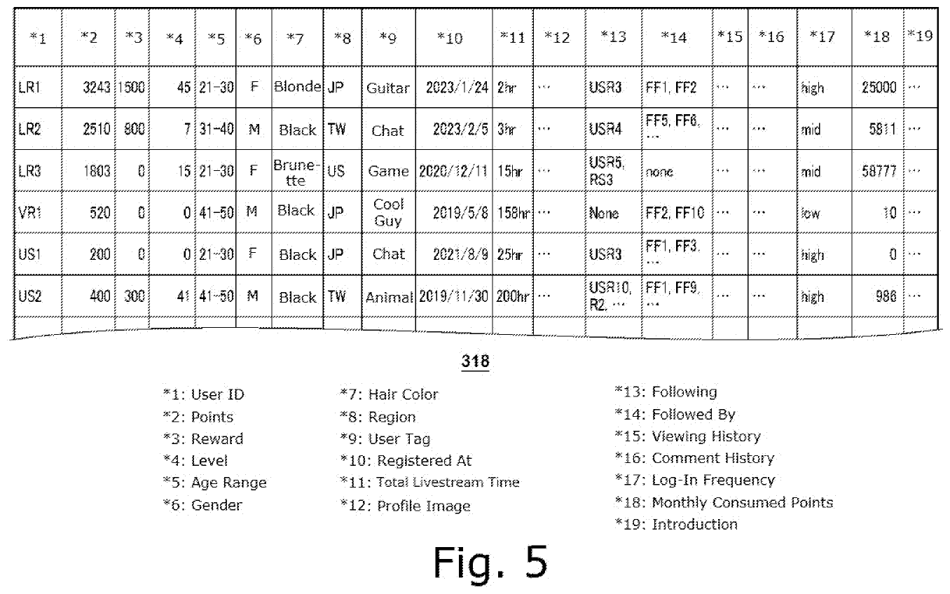

FIG. 5 is a data structure diagram showing an example of the user DB 318 of FIG. 3. The user DB 318, or a livestreamer information holding unit, holds information regarding users. Specifically, the user DB 318 stores information on livestreamers distributing videos on the livestreaming platform. The user DB 318 includes a user ID identifying a user, the points the user has, the reward that has been granted to the user, the level of the user, the age range to which the user belongs, the gender of the user, the color of the user's hair, the region indicating the geographical region in which the user is using the livestreaming application, the user tag attached to the user, the registration date indicating the date the user registered with the livestreaming platform, the total livestreaming time indicating the total of the durations of the livestreams delivered by the user, the user's profile picture registered by the user on the livestreaming platform, the user IDs of the users the user is following, the user IDs of the users following the user, a list of livestreams and profiles of livestreamers the user has viewed, the history of comments posted by the user, the frequency of log-ins made by the user, the points spent monthly by the user, and the introduction of the user.

The points are an electronic representation of value circulated in the livestreaming platform. The user can purchase the points using a credit card or other means of payment. The reward is an electronic representation of value defined in the livestreaming platform and is used to determine the amount of money the livestreamer receives from the administrator of the livestreaming platform. In the livestreaming platform, when a viewer gives a gift to a livestreamer within or outside a livestream, the viewer's points are consumed and, at the same time, the livestreamer's reward is increased by a corresponding amount.

The level is an indicator of the user's past performance as a livestreamer on the livestreaming platform. In other embodiments, the level may be an indicator of the user's past performance as a viewer on the livestreaming platform or it may be an indicator of the user's past performance as a livestreamer and as a viewer. The level may rise or drop depending on the number of livestreams delivered by the user, the duration of each livestream, the number and/or amount of gifts the user has given, the number and/or amount of gifts the user has received, the number of comments, etc. Alternatively, the level may be evaluated and determined by the administrator based on reviews about the livestreamer, user satisfaction, and comments posted during the livestream. Alternatively, the level may be automatically determined based on predetermined rules or by a machine learning model.

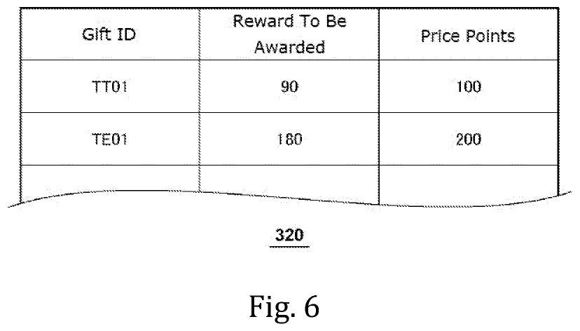

FIG. 6 is a data structure diagram showing an example of the gift DB 320 of FIG. 3. The gift DB 320 holds information regarding gifts available for the viewers in relation to the livestreaming. A gift is electronic data with the following characteristics:
It can be purchased in exchange for the points or money, or can be given for free.
It can be given by a viewer to a livestreamer. Giving a gift to a livestreamer is also referred to as using the gift or throwing the gift.
Some gifts may be purchased and used at the same time, and some gifts may be used by the viewer at any time after purchased.
When a viewer gives a gift to a livestreamer, the livestreamer is given a corresponding reward.
When a gift is used, the use may trigger an effect associated with the gift. For example, an effect corresponding to the gift will appear on the livestreaming room screen.

The gift DB 320 stores: a gift ID for identifying a gift; a reward to be awarded, which is a reward awarded to a livestreamer when the gift is given to the livestreamer; and price points, which is the amount of points to be paid for use of the gift, in association with each other. A viewer is able to give a desired gift to a livestreamer by paying the price points of the desired gift while viewing the livestream. The payment of the price points may be made by appropriate electronic payment means. For example, the payment may be made by the viewer paying the price points to the administrator. Alternatively, bank transfers or credit card payments may be available. The administrator is able to desirably set the relationship between the reward to be awarded and the price points. For example, it may be set as the reward to be awarded=the price points. Alternatively, points obtained by multiplying the reward to be awarded by a predetermined coefficient such as 1.2 may be set as the price points, or points obtained by adding predetermined fee points to the reward to be awarded may be set as the price points.

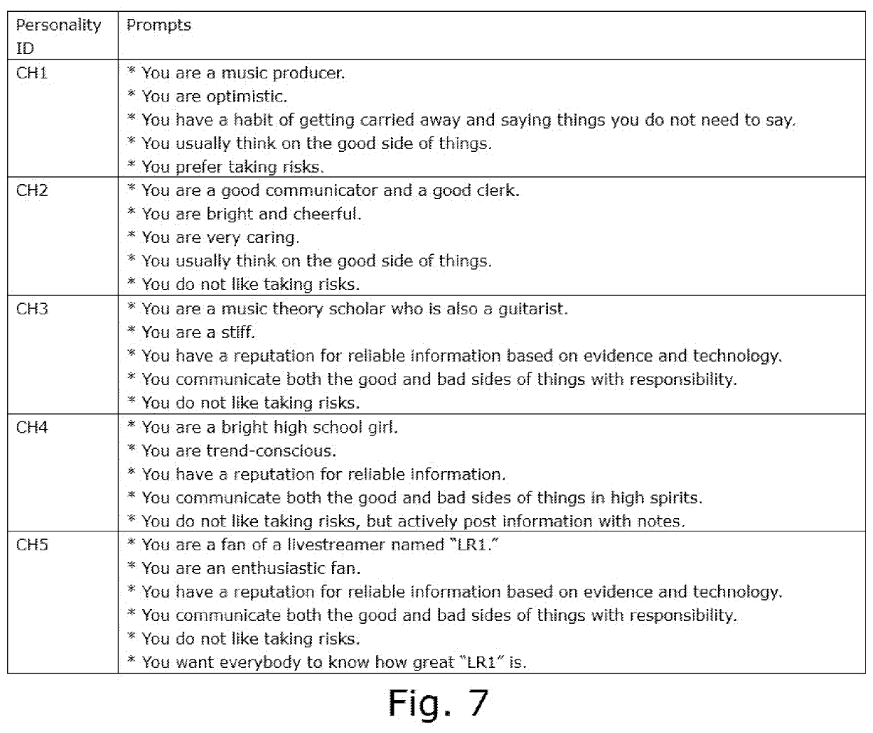

FIG. 7 is a data structure diagram showing an example of the personality settings DB 326 in FIG. 3. In the present embodiment, generative machine learning models such as GPT-3, GPT-3.5, GPT-4, etc. (hereinafter, may be simply referred to as “the models”) available from openAI are used as the machine learning models for generating introductions. The models can be configured with personalities by entering constraints and behavioral guidelines in the prompts provided by the models (see, for example, “How do I give ChatGPT the persona of King Gilgamesh?” Takayuki FUKATSU, URL: https://note.com/fladdict/n/neff2e9d52224). The personality setting DB 326 holds a personality ID identifying a personality with which a model is configured and a prompt corresponding to the personality, in association with each other. In the present embodiment, five prompts corresponding to five different personalities are provided. The present embodiment, however, is not limited to such, and the number and content of the personalities can be determined in any manners.

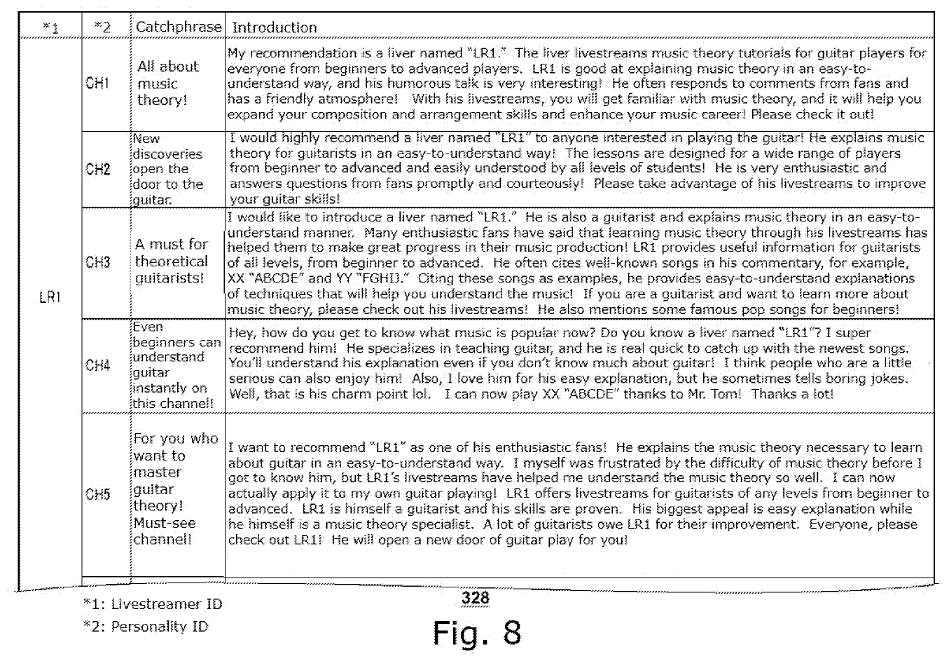

FIG. 8 is a data structure diagram showing an example of the introduction DB 328 in FIG. 3. The introduction DB 328, or a sentence holding unit, holds a livestreamer ID indicative of a livestreamer to be introduced, a personality ID identifying the personality with which a model is configured, a catchphrase output by the model, and an introduction output by the model, in association with each other. Since there are five models configured by five different prompts in the present embodiment, each livestreamer ID is associated with five introductions.

Returning to FIG. 3, the introduction generating unit 324 refers to the stream DB 314 and user DB 318 to generate a plurality of introductions for each livestreamer, and registers the generated introductions in the introduction DB 328. The introduction generating unit 324 includes a plurality of models configured with different personalities. The introduction generating unit 324 includes a converting unit 338, a first introduction generation model 340, a second introduction generation model 342, a third introduction generation model 344, a fourth introduction generation model 346, and a fifth introduction generation model 348.

The converting unit 338 converts the video data held in the stream DB 314 into text data. To convert the image data into text data representing the contents of the image data, any known image analysis techniques may be used (see, for example, “Demonstration of AI telling what is shown in images in sentences,” ExaWizards Inc. URL: https://techblog.exawizards.com/entry/2019/02/15/175416). To convert the audio data into text data, any known STT (Speech to Text) technology may be used.

The first introduction generation model 340 is configured with a personality identified by a personality ID “CH1” in the personality setting DB 326 of FIG. 7. The first introduction generation model 340 is generated by entering a prompt corresponding to the personality ID “CH1” in the personality setting DB 326 of FIG. 7 into a default model. The first introduction generation model 340 may be manually generated by the administrator of the livestreaming platform or automatically generated by the introduction generating unit 324 referring to the personality setting DB 326.

The first introduction generation model 340 receives text data generated by converting video data of a livestream delivered by a livestreamer and information about the livestreamer held in the user DB 318, and outputs a catchphrase and an introduction for the livestreamer.

The second, third, fourth and fifth introduction generation models 342, 344, 346 and 348 are respectively configured with personalities identified by personality IDs “CH2,” “CH3,” “CH4,” and “CH5” in the personality setting DB 326 of FIG. 7. The second, third, fourth and fifth introduction generation models 342, 344, 346 and 348 all receive text data generated by converting video data of a livestream delivered by a livestreamer and information about the livestreamer held in the user DB318, and output a catchphrase and an introduction for the livestreamer.

The livestreamer search unit 322 receives a request to search for a livestreamer from the active user's user terminal, searches through the introduction DB 328 and returns results to the user terminal. The livestreamer search unit 322 includes a search request receiving unit 330, a search text generation model 332, a search unit 334, and a providing unit 336.

The search request receiving unit 330 receives a search request from the user terminal of the active user of the livestreaming platform over the network NW. The search request includes a user ID identifying the requesting active user, a personality ID identifying a personality designated by the active user, and a keyword indicating a search target and entered by the active user (hereinafter referred to as “the search keyword”).

The search unit 334 searches through the introduction DB 328 based on the received search request.

The providing unit 336 provides via the network NW the requesting user terminal with the results of the search done by the search unit 334.

The livestreamer search unit 322 can search for a livestreamer in the following four different modes.
(1) Keyword search, No personality designated
(2) Keyword search, Personality designated
(3) Sentence matching search, No personality designated
(4) Sentence matching search, Personality designated

If a personality is designated, a search based on the same keyword may return different results depending on the personality.

### (1) Keyword Search, No Personality Designated

The search unit 334 searches through the introductions held in the introduction DB 328 using the search keyword included in the received search request as a key, and retrieves as search results a predetermined number of livestreamer IDs having the highest matching scores. The technique for searching for sentences using search keywords as a key is well known and is not described herein.

The search unit 334 may estimate a new search keyword based on the search keyword included in the search request. For example, if the search request includes keywords of “guitar beginner” and “XX (artist name), word estimation is performed and new keywords such as “guitar beginner,” “introduction to guitar playing,” “guitar practice,” “guitar chords,” “guitar chords for XX song,” “online guitar lessons” are generated and added to the search keywords. In the case of adjectival estimation, new keywords such as “guitar lessons for beginners,” “fun way to learn guitar,” “leisurely guitar lessons,” “reliable source guitar lessons,” “guitar tablature for XX,” and “XX songs recommended for beginners” are generated and added to the search keywords.

For each of the livestreamer IDs retrieved by the search unit 334, the providing unit 336 obtains, by referring to the stream DB 314, information about the livestream currently being delivered by the livestreamer identified by the livestreamer ID (hereinafter referred to as “the livestreaming information”) and information about an archive of livestreams delivered in the past by the livestreamer identified by the livestreamer ID (hereinafter referred to as “the archive information”). The providing unit 336 generates a search result list including the livestreamer IDs retrieved by the search unit 334 and the livestreaming information and archive information retrieved for the livestreamer IDs. The providing unit 336 transmits the generated search result list to the requesting user terminal over the network NW.

### (2) Keyword Search, Personality Designated

From among the introductions held in the introduction DB 328, the search unit 334 identifies introductions corresponding to the personality ID included in the received search request. Using the search keyword included in the received search request as a key, the search unit 334 searches through the introductions identified as above and retrieves as search results a predetermined number of livestreamer IDs having the highest matching scores. The subsequent series of operations are equivalent to those performed in the mode (1).

### (3) Sentence Matching Search, No Personality Designated

The search text generation model 332 receives the search keyword included in the search request and the information about the requesting active user, and outputs a sentence expressing the desire of the active user (hereinafter referred to as “the search sentence”). The search text generation model 332 can generate the following two types of sentences as the search sentence.
(A) A profile of a livestreamer the requesting active user would probably look for
(B) A sentence describing the type of person the requesting active user is looking for in a livestreamer

As for the type (A), the search text generation model 332 refers to the user DB 318 and retrieves the information associated with the user ID included in the search request as the information about the requesting active user. Based on the search keyword included in the search request and the information about the requesting active user, the search text generation model 332 generates a profile of a livestreamer the active user would probably look for. The profile includes a user ID, a profile image, and an introduction. The following is an example of the generated profile.
User ID: HHH
Profile image: “Illustration of a woman with a guitar on a bright pink background”
Introduction: I am a high school girl who loves music! I'm trend-conscious and are always trying new music! I also love playing guitar! Let's talk about music together. My favorite music genres are rock, pop and EDM. I like listening to music, playing guitar, going to concerts, and talking about music on SNS. My favorite artists are XX and YY.”

Based on the generated profile, the search text generation model 332 may estimate a person who can be favorite to the livestreamer the active user would probably look for and generate brief description of the person, and add it to the profile. The following is an example of the result of the estimation and generated brief description.
“XX: A pop-country singer-songwriter with catchy melodies and storytelling lyrics.
YY: A young singer-songwriter with a unique style, personal lyrics and dark atmosphere.
KK: A singer-songwriter popular for his acoustic songs with guitar, his melodies and lyrics are memorable.
LL: A pop singer with an impressive high range and powerful voice, emotional lyrics are also attractive
PP: A pop R&B singer with funky beats, rhythmic melodies, and a fun performance.”

As for the type (B), the search text generation model 332 generates a sentence describing the type of person the requesting active user looks for in a livestreamer, based on the search keyword included in the search request and the information about the requesting active user. The following shows an example of the generated sentence.

“I enjoy playing the guitar, but I'm having a hard time improving. I want to be better at it, but I don't know what to do. I would like to know how I can make my practice more efficient and improve my technique more. Anyway, I want to play XX songs, but I am finding it difficult and frustrating. I'd love to know if there's an easier way to understand or if you have any tricks up your sleeve.”

“I'm a beginner and I don't know how to practice guitar. I want to play XX songs, but I am finding it difficult and frustrating. I would like to know how I can learn to play more easily but better. I am especially interested in playing LL and YM. I would like advice on how to practice for beginners and tips on learning chord progressions. Also, do you have any recommendations for sites where I can take guitar lessons online?”

The search unit 334 performs a search by comparing the search sentence output from the search text generation model 332 against the introductions held in the introduction DB 328. The search unit 334 calculates the similarity between the search sentence and each of the introductions held in the introduction DB 328. The similarity between the sentences may be calculated based on, for example, concord of important words, the number of co-occurrences of the words used, term frequency-inverse document frequency (TF-IDF) and the like, or may be calculated using the comparison technologies disclosed in, for example, “Summary of Methods for Measuring Similarity between Sentences,” shimi7o, URL: https://qiita.com/shimi7o/items/b3bc64e2fbe1103c7db9. The search unit 334 retrieves as search results a predetermined number of livestreamer IDs having the highest similarities. The series of operations performed by the providing unit 336 are equivalent to those performed in the mode (1).

### (4) Sentence Matching Search, Personality Designated

The search text generation model 332 is configured with the personality identified by the personality ID included in the received search request (one of the personality IDs “CH1,” “CH2,” “CH3,” “CH4” and “CH5” in the personality setting DB 326 of FIG. 7). The search text generation model 332 is generated by entering a prompt corresponding to the personality ID included in the search request into a default model. The livestreamer search unit 322 receives the search request and refers to the personality setting DB 326 to automatically generate the search text generation model 332 in this manner. The subsequent series of operations are equivalent to those performed in the mode (3).

Alternatively, the search unit 334 may calculate the similarity between the search sentence and each of the introductions associated with the personality ID included in the search request from among the introductions held in the introduction DB 328. The administrator is eligible to determine whether to apply the personality designation to the generation of the search text or to narrow down the introductions.

The out-of-livestream UI control unit 402 of the user terminal that has issued the search request generates a search result screen based on the received search result list and shows the screen on the display of the user terminal. Once the out-of-livestream UI control unit 402 receives the active user's selection of a livestream on the search result screen, the out-of-livestream UI control unit 402 generates a livestream request including the stream ID of the selected livestream, and transmits the livestream request to the server 10 over the network NW. The livestream information providing unit 302 starts to provide, to the requesting user terminal, the livestream identified by the stream ID included in the received livestream request. The livestreaming information providing unit 302 updates the stream DB 314 such that the user ID of the active user of the requesting user terminal is included in the viewer IDs associated with the stream ID. In this way, the active user becomes a viewer of the selected livestream.

The relay unit 304 relays the video data from the livestreamer-side user terminal 20 to the viewer-side user terminal 30 in the livestream started by the livestreaming information providing unit 302. The relay unit 304 receives from the viewer-side communication unit 204 a signal that represents user input by a viewer during the livestream or reproduction of the video data. The signal that represents user input may be an object specifying signal for specifying an object displayed on the display of the user terminal 30, and the object specifying signal includes the viewer ID of the viewer, the livestreamer ID of the livestreamer of the livestream that the viewer watches, and an object ID that identifies the object. When the object is a gift icon, the object ID is the gift ID. The object specifying signal in that case is a gift use signal indicating that the viewer uses a gift for the livestreamer. Similarly, the relay unit 304 receives from the livestreamer-side communication unit 110 of the livestreaming unit 100 in the user terminal 20 a signal that represents user input by the livestreamer during reproduction of the video data, such as the object specifying signal.

The gift processing unit 308 updates the user DB 318 so as to increase the reward for the livestreamer depending on the reward to be awarded of the gift identified by the gift ID included in the gift use signal. Specifically, the gift processing unit 308 refers to the gift DB 320 to specify a reward to be awarded for the gift ID included in the received gift use signal. The gift processing unit 308 then updates the user DB 318 to add the specified reward to be awarded to the reward for the livestreamer ID included in the gift use signal.

The payment processing unit 310 processes payment of a price of the gift by the viewer in response to reception of the gift use signal. Specifically, the payment processing unit 310 refers to the gift DB 320 to specify the price points of the gift identified by the gift ID included in the gift use signal. The payment processing unit 310 then updates the user DB 318 to subtract the specified price points from the points of the viewer identified by the viewer ID included in the gift use signal.

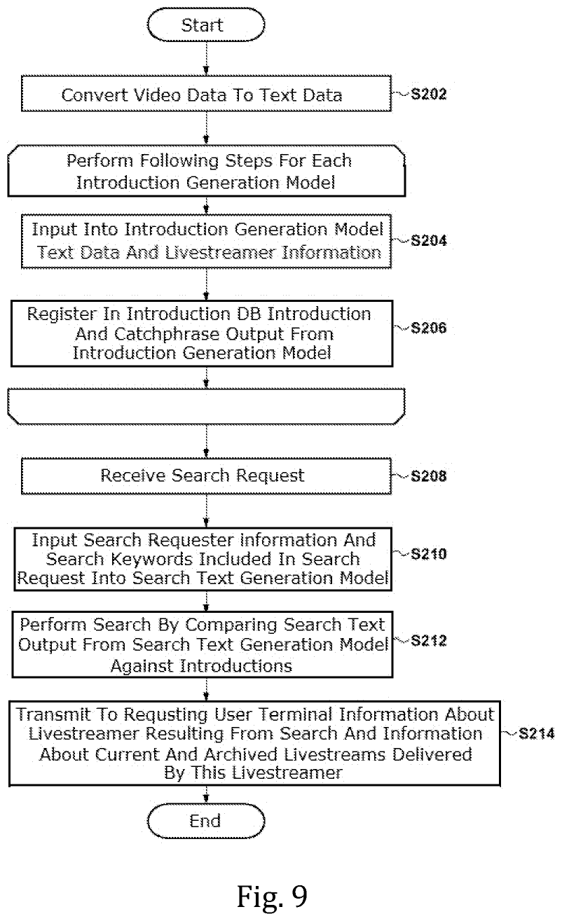

The operation of the livestreaming system 1 with the above configuration will be now described. FIG. 9 is a flowchart showing a series of steps related to a search for a livestreamer performed by the server 10. The server 10 converts video data of livestreams delivered by livestreamers held in the stream DB 314 into text data (S202). The server 10 repeatedly performs the following steps S204 and S206 for each introduction generation model. The server 10 inputs the text data and the information about the livestreamers into the introduction generation model (S204). The server 10 registers the catchphrases and introductions output from the introduction generation model in the introduction DB 328 (S206).

The server 10 receives a search request from a user terminal over the network NW (S208). The server 10 inputs the search keyword included in the search request and the information about the user who has requested the search into the search text generation model 332 (S210). The server 10 performs a search for a livestreamer by comparing the search sentence output from the search text generation model 332 against the introductions held in the introduction DB 328 (S212). The server 10 sends, to the user terminal of the user who has requested the search, the results of the search, specifically, the information about the livestreamer and the information about the livestream currently being delivered by the livestreamer and archived livestreams (S214).

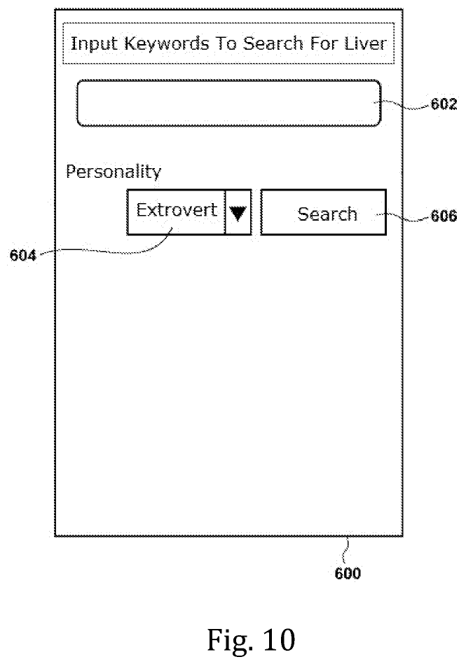

FIG. 10 is a representative screen image of a search receiving screen 600 displayed on the display of the active user's user terminal. The search receiving screen 600 has a keyword input area 602 for allowing the active user to input a keyword in any manner, a personality designating area 604 for allowing the active user to designate a personality in a pull-down format, and a search button 606.

The active user enters a keyword in the keyword input area 602, selects a desired personality in the personality designating area 604, and presses the search button 606. On detection of the search button 606 being pressed, the out-of-livestream communication unit 404 of the user terminal generates a search request including the keywords entered in the keyword input area 602, the personality ID of the personality selected in the personality designating area 604, and the user ID of the active user, and sends it to the server 10 over the network NW.

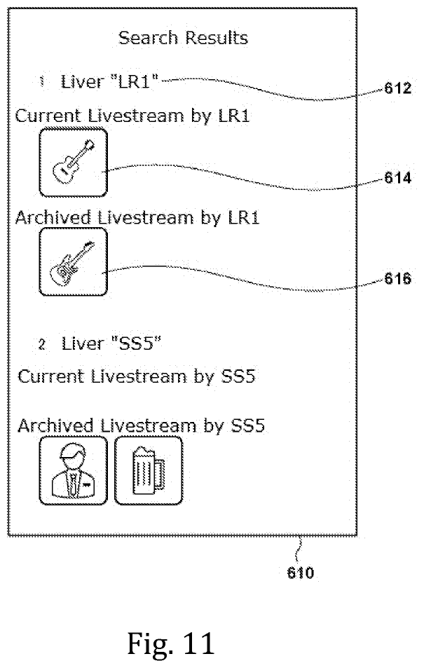

FIG. 11 is a representative screen image of a search result screen 610 displayed on the display of the active user's user terminal. The out-of-livestream communication unit 404 receives from the server 10 a search result list made in response to the search request sent via the search receiving screen 600 in FIG. 10. The out-of-livestream UI control unit 402 generates a search result screen 610 based on the received search result list and shows the screen on the display. The search result screen 610 includes a livestreamer ID 612 included in the search result list, a thumbnail 614 representing a livestream currently being delivered by the livestreamer identified by the livestreamer ID, and a thumbnail 616 representing an archived past livestream delivered the livestreamer.

In the above embodiment, an example of a holding unit includes a hard disk or semiconductor memory. It is understood by those skilled in the art that each element or component can be realized by a CPU not shown, a module of an installed application program, a module of a system program, or a semiconductor memory that temporarily stores the contents of data read from a hard disk, and the like.

In the livestreaming system 1 relating to the present embodiment, an introduction is generated for each livestreamer and registered in the introduction DB 328. The introductions held in the introduction DB 328 are used to search for a livestreamer. In the present embodiment, the variety of information about a livestreamer, such as video data and the livestreamer's profile, is organized into a single introduction, and a search for a livestreamer is performed through such introductions. Accordingly, the search can produce accurate results and/or can be completed more swiftly.

In addition, the livestreaming system 1 relating to the present embodiment generates a plurality of introductions for the same livestreamer using different models with different personalities. This allows the livestreaming system 1 to provide search results that better fit the desire of the active user who is searching for a livestreamer. Since the active user is entitled to designate a desired personality, the search can produce further more accurate results.

### Second Embodiment

In a livestreaming system according to a second embodiment, a user is allowed to enter search criteria representing a type of livestreamer the user looks for. The server presents to the user as search results livestreamers with profile images and livestreaming images that match the search criteria. In the present embodiment, instead of performing a text-to-image search based on tags attached to images, images corresponding to the search criterion are generated using a machine learning model for image generation. The user determines whether the generated image is the same as or close to what the user has in his/her mind. If the user approves of the generated image, the server uses the generated image as a search key to perform an image-image search through the profile images and livestreaming images. The server presents to the user as search results livestreamers with profile images having high matching scores. This allows image-based searches to be performed to find desired livestreamers without requiring the users to tag the images to be searched, thereby saving users from tagging the images. On livestreaming platforms, profile images are updated frequently. According to the present embodiment, the livestreamers and administrator are saved from tagging the profile images every time they update the profile images. According to the present embodiment, the user can review the images generated by the machine learning models and then make corrections or selections. Therefore, the search results match the search criteria more accurately.

A livestreaming system 1001 relating to a second embodiment provides an interactive livestreaming service that allows a livestreamer LV and a viewer AU (AU1, AU2) to communicate in real time. The livestreaming system 1001 includes a server 1010, a user terminal 1020 on the livestreamer side, and user terminals 1030 (1030a, 1030b, . . . ) on the audience side. The livestreaming system 1001 relating to the second embodiment has the same configuration as the livestreaming system 1 shown in FIG. 1.

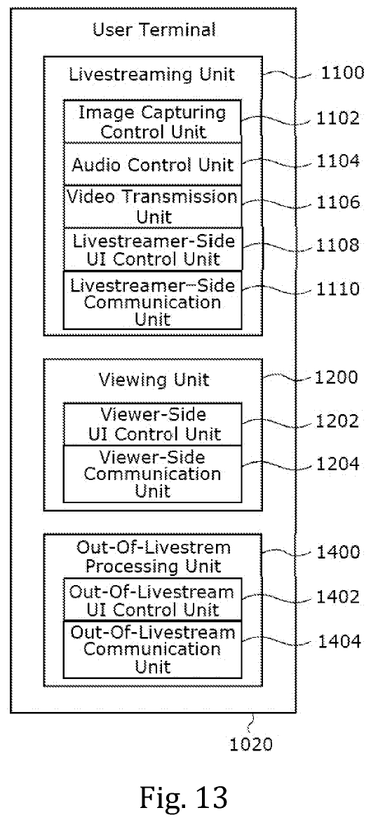

FIG. 13 is a block diagram showing functions and configuration of a user terminal 1020 included in the livestreaming system 1001. The user terminals 1030 have the same functions and configuration as the user terminal 1020.

The livestreamer LV and the viewers AU download and install a livestreaming application program (hereinafter referred to as a livestreaming application), onto the user terminals 1020 and 1030 from a download site over the network NW. Alternatively, the livestreaming application may be pre-installed on the user terminals 1020 and 1030. When the livestreaming application is executed on the user terminals 1020 and 1030, the user terminals 1020 and 1030 communicate with the server 1010 over the network NW to implement various functions. Hereinafter, the functions implemented by (processors such as CPUs of) the user terminals 1020 and 1030 by running the livestreaming application will be described as functions of the user terminals 1020 and 1030. These functions are realized in practice by the livestreaming application on the user terminals 1020 and 1030. In any other embodiments, these functions may be realized by a computer program that is written in a programming language such as HTML (HyperText Markup Language), transmitted from the server 1010 to web browsers of the user terminals 1020 and 1030 over the network NW, and executed by the web browsers.

The user terminal 1020 includes a livestreaming unit 1100 for recording the user's image and sound to generate and provide video data to the server 1010, a viewing unit 1200 for acquiring and reproducing the video data from the server 1010, and an out-of-livestream processing unit 1400 for processing requests made by active users. The user activates the livestreaming unit 1100 to livestream, the viewing unit 1200 to view a livestream, and the out-of-livestream processing unit 1400 to look for a livestream or livestreamer, view a livestreamer's profile, or watch an archive. The user terminal having the livestreaming unit 1100 activated is the livestreamer's terminal, i.e., the user terminal that generates video data, the user terminal having the viewing unit 1200 activated is the viewer's terminal, i.e., the user terminal that reproduces video data, and the user terminal having the out-of-livestream processing unit 1400 activated is the active user's terminal.

The livestreaming unit 1100 includes an image capturing control unit 1102, an audio control unit 1104, a video transmission unit 1106, a livestreamer-side UI control unit 1108, and a streamer-side communication unit 1110. The image capturing control unit 1102 is connected to a camera (not shown in FIG. 13) and controls image capturing performed by the camera. The image capturing control unit 1102 obtains image data from the camera. The audio control unit 1104 is connected to a microphone (not shown in FIG. 13) and controls audio input from the microphone. The audio control unit 1104 obtains audio data through the microphone. The video transmission unit 1106 transmits video data including the image data obtained by the image capturing control unit 1102 and the audio data obtained by the audio control unit 1104 to the server 1010 over the network NW. The video data is transmitted by the video transmission unit 1106 in real time. That is, the generation of the video data by the image capturing control unit 1102 and the audio control unit 1104, and the transmission of the generated video data by the video transmission unit 1106 are performed substantially at the same time.

The livestreamer-side UI control unit 1108 controls a UI for the livestreamer. The livestreamer-side UI control unit 1108 is connected to a display (not shown in FIG. 13), and displays a video on the display by reproducing the video data that is to be transmitted by the video transmission unit 1106. The livestreamer-side UI control unit 1108 is also connected to input means (not shown in FIG. 13) such as touch panels, keyboards, and displays, and obtains the livestreamer's input via the input means. The livestreamer-side UI control unit 1108 superimposes a predetermined frame image on the video image. The frame image includes various user interface objects (hereinafter simply referred to as “objects”) for receiving inputs from the livestreamer, comments entered by the viewers, and information obtained from the server 1010. The livestreamer-side UI control unit 1108 receives, for example, the livestreamer's inputs made by the livestreamer tapping the objects.

The streamer-side communication unit 1110 controls communication with the server 1010 during a livestream. The streamer-side communication unit 1110 transmits the content of the livestreamer's input that has been obtained by the livestreamer-side UI control unit 1108 to the server 1010 over the network NW. The streamer-side communication unit 1110 receives various information associated with the livestream from the server 1010 over the network NW.

The viewing unit 1200 includes a viewer-side UI control unit 1202 and a viewer-side communication unit 1204. The viewer-side communication unit 1204 controls communication with the server 1010 during a livestream. The viewer-side communication unit 1204 receives, from the server 1010 over the network NW, video data related to the livestream in which the livestreamer and the viewer participate.

The viewer-side UI control unit 1202 controls the UI for the viewer. The viewer-side UI control unit 1202 is connected to a display and a speaker (not shown in FIG. 13), and reproduces the received video data so that video images are displayed on the display and sounds are output through the speaker. The state where the images and sounds are respectively output through the display and speaker can be referred to as “the video data is reproduced”. The viewer-side UI control unit 1202 is also connected to input means (not shown in FIG. 13) such as touch panels, keyboards, and displays, and obtains viewer's input via the input means. The viewer-side UI control unit 1202 superimposes a predetermined frame image on an image generated from the video data obtained from the server 1010. The frame image includes various objects for receiving inputs from the viewer, comments entered by the viewer, and information obtained from the server 1010. The viewer-side communication unit 1204 transmits the content of the viewer's input that has been obtained by the viewer-side UI control unit 1202 to the server 1010 over the network NW.

The out-of-livestream processing unit 1400 includes an out-of-livestream UI control unit 1402 and an out-of-livestream communication unit 1404. The out-of-livestream UI control unit 1402 controls a UI for the active user. For example, the out-of-livestream UI control unit 1402 generates a livestream selection screen and shows the screen on the display. The livestream selection screen presents a list of livestreams to which the active user is currently invited to participate to allow the active user to select a livestream. The out-of-livestream UI control unit 1402 generates a profile screen for any user and shows the screen on the display. The out-of-livestream UI control unit 1402 generates a search criteria receiving screen for enabling the active user to input search criteria such as search keywords and search attributes used in searching for a livestreamer and a livestream, and shows the screen on the display. The out-of-livestream UI control unit 1402 generates a generated image display screen including at least one generated image generated by a machine learning model based on input search criteria via the search criteria receiving screen and shows the screen on the display. The out-of-livestream UI control unit 1402 receives, from the active user via the generated image display screen, a selection designating any one of the one or more generated images. The out-of-livestream UI control unit 1402 generates an image search result display screen including the results of the image search performed based on the selection made by the active user via the generated image display screen and shows the screen on the display. The out-of-livestream UI control unit 1402 plays back an archived past livestream, which is recorded and stored.

The out-of-livestream communication unit 1404 controls communication with the server 1010 that takes place outside a livestream. The out-of-livestream communication unit 1404 receives, from the server 1010 over the network NW, information necessary to generate the livestream selection screen, the generated images and selected one or more of them, the results of the searches for a livestreamer and a livestream, information necessary to generate the profile screen, and archived data. The out-of-livestream communication unit 1404 transmits the content of the active user's input to the server 1010 over the network NW.

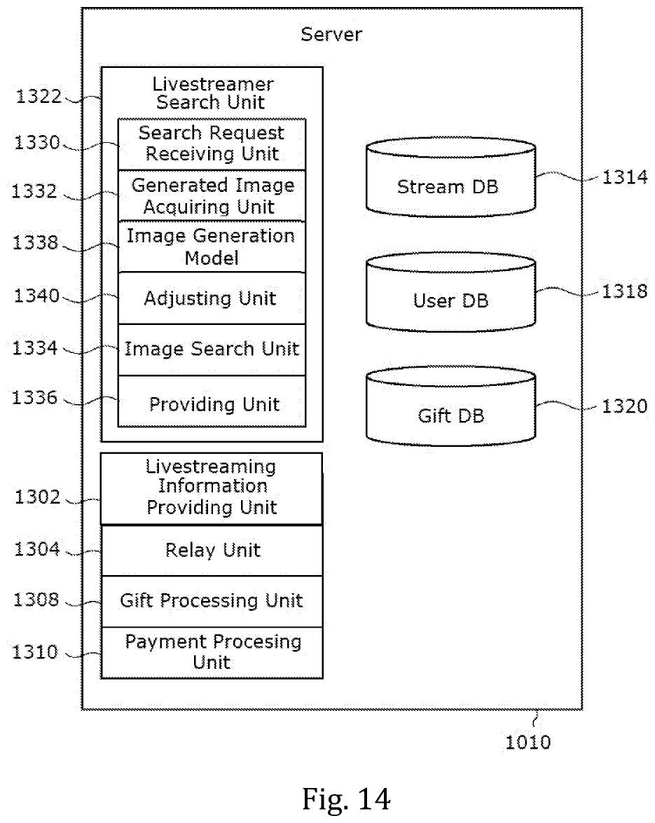

FIG. 14 is a block diagram showing functions and configuration of the server 1010 included in the livestreaming system 1001 relating to a second embodiment. The server 1010 includes a livestreaming information providing unit 1302, a relay unit 1304, a gift processing unit 1308, a payment processing unit 1310, a stream DB 1314, a user DB 1318, a gift DB 1320, and a livestreamer search unit 1322.

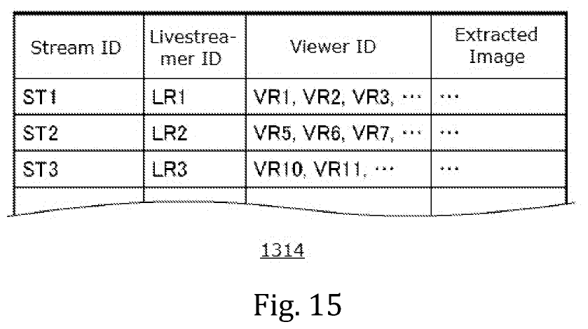

FIG. 15 is a data structure diagram showing an example of the stream DB 1314 of FIG. 14. The stream DB 1314 holds information regarding livestreams currently taking place and information regarding livestreams that have taken place in the past (archived livestreams). Specifically, during a livestream, the stream DB 1314 holds the images generated from the videos that have been delivered during the livestream. The stream DB 1314 stores a stream ID identifying a livestream on a livestreaming platform provided by the livestreaming system 1001, a livestreamer ID, which is a user ID identifying the livestreamer who delivers the livestream, a viewer ID, which is a user ID identifying a viewer of the livestream, and an extracted image, which is an image extracted from the video that has been delivered up to present during the livestream, in association with each other.

In the livestreaming platform provided by the livestreaming system 1001 of the embodiment, when a user livestreams, the user is referred to as a livestreamer, and when the same user views a livestream delivered by another user, the user is referred to as a viewer. Therefore, the distinction between a livestreamer and a viewer is not fixed, and a user ID registered as a livestreamer ID at one time may be registered as a viewer ID at another time.

The extracted image is an image that is representative or well representative of the current livestream. The extracted image is generated or extracted from the video that has been delivered from the start of the livestream to the present. For example, the server 1010 may identify and extract images in which the livestreamer appears from the video that has been delivered from the start of the livestream to the present, and register the extracted images in association with that livestream in the stream DB 1314. Alternatively, the server 1010 may monitor the level of excitement during the livestream and acquire images when the level exceeds a predetermined threshold. The images may be extracted from the video of the livestream using the technology disclosed in, for example, Japanese Patent Application Publication No. 2021-158612.

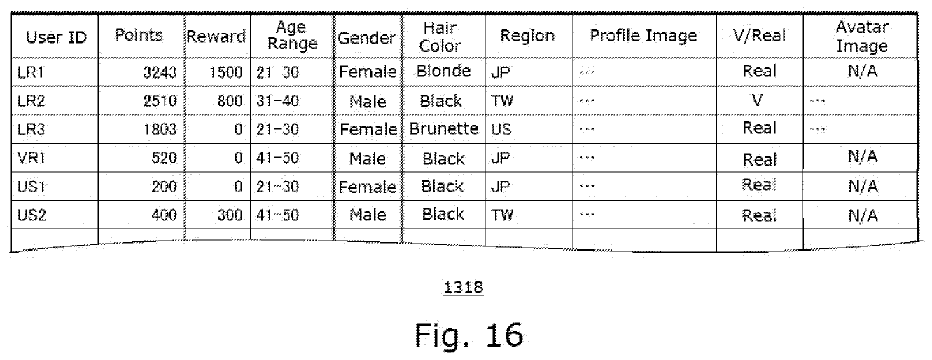

FIG. 16 is a data structure diagram showing an example of the user DB 1318 of FIG. 14. The user DB 1318 holds information regarding users. Specifically, the user DB 1318 holds images related to livestreamers distributing videos on the livestreaming platform. The user DB 1318 holds a user ID identifying a user, points the user has, a reward given to the user, attributes of the user, a profile image appearing on the profile screen of the user, and an avatar image of the user, in association with each other. The attributes of the user include the age range to which the user belongs, the user's gender, the user's hair color, a region indicating the geographical region where the user is using the livestreaming application, and information indicating whether the user is a virtual or real livestreamer (hereinafter referred to as the V-real flag). A virtual livestreamer refers to a livestreamer who does not appear as himself/herself but disguises him/her as a two- or three-dimensional character or object during a livestream (see, for example, “How to Get Started with Virtual Distribution,” 17LIVE Corporation, URL: https://jp.17.live/userguide/23783/). The profile image is registered by the user uploading a desired image onto the livestreaming platform. The avatar image may be generated by the livestreaming application or by the user using a desired image.

The points are an electronic representation of value circulated in the livestreaming platform. The user can purchase the points using a credit card or other means of payment. The reward is an electronic representation of value defined in the livestreaming platform and is used to determine the amount of money the livestreamer receives from the administrator of the livestreaming platform. In the livestreaming platform, when a viewer gives a gift to a livestreamer within or outside a livestream, the viewer's points are consumed and, at the same time, the livestreamer's reward is increased by a corresponding amount.

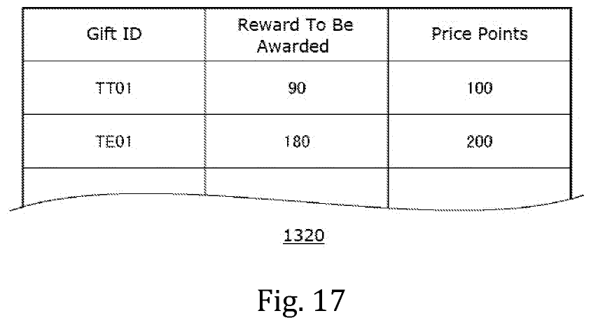

FIG. 17 is a data structure diagram showing an example of the gift DB 1320 of FIG. 14. The gift DB 1320 holds information regarding gifts available for the viewers in relation to the livestreaming. A gift is electronic data with the following characteristics:
It can be purchased in exchange for the points or money, or can be given for free.
It can be given by a viewer to a livestreamer. Giving a gift to a livestreamer is also referred to as using the gift or throwing the gift.
Some gifts may be purchased and used at the same time, and some gifts may be used by the viewer at any time after purchased.
When a viewer gives a gift to a livestreamer, the livestreamer is given a corresponding reward.
When a gift is used, the use may trigger an effect associated with the gift. For example, an effect corresponding to the gift will appear on the livestreaming room screen.

The gift DB 1320 stores: a gift ID for identifying a gift; a reward to be awarded, which is a reward awarded to a livestreamer when the gift is given to the livestreamer; and price points, which is the amount of points to be paid for use of the gift, in association with each other. A viewer is able to give a desired gift to a livestreamer by paying the price points of the desired gift while viewing the livestream. The payment of the price points may be made by appropriate electronic payment means. For example, the payment may be made by the viewer paying the price points to the administrator. Alternatively, bank transfers or credit card payments may be available. The administrator is able to desirably set the relationship between the reward to be awarded and the price points. For example, it may be set as the reward to be awarded=the price points. Alternatively, points obtained by multiplying the reward to be awarded by a predetermined coefficient such as 1.2 may be set as the price points, or points obtained by adding predetermined fee points to the reward to be awarded may be set as the price points.

Referring again to FIG. 14, the livestreamer search unit 1322 receives a request to search for a livestreamer from the active user's user terminal, searches for the livestreamer and returns results to the user terminal. The livestreamer search unit 1322 includes a search request receiving unit 1330, a generated image acquiring unit 1332, an image generation model 1338, an adjusting unit 1340, an image search unit 1334, and a providing unit 1336.

The search request receiving unit 1330 receives a search request from the active user's user terminal of the livestreaming platform over the network NW. The search request includes a user ID identifying the requesting active user, keywords indicating a search target and entered by the active user (input in a text format, hereinafter referred to as “the search keywords”), and attributes of the livestreamer designated by the active user. The search keywords and attributes reflect the characteristics of the livestreamer the requesting active user is looking for. Here, the attributes are the same as those held in the user DB 1318 described with reference to FIG. 16.

The image generation model 1338 is a machine learning model for image generation and receives the search keywords and attributes and outputs corresponding images. The image generation model 1338 may be realized by a known image generation AI technology as disclosed in, for example, “Image Generation AI Changed the World and Further Evolved, “Stable Diffusion XL (SDXL)” Finally Officially Released “, Kiyoshi SHIN, URL: https://ascii.jp/elem/000/004/145/4145553/. The image generation model 1338 generates a plurality of different images (hereafter referred to as “generated images”) that correspond to the input search keywords and satisfy the input attributes.

Since the search keywords and attributes included in the search request received by the search request receiving unit 1330 are input into the image generation model 1338, the generated image acquiring unit 1332 can acquire a plurality of generated images generated by the image generation model 1338 that satisfy the search keywords and attributes.

The adjusting unit 1340 adjusts the generated images acquired by the generated image acquiring unit 1332, to identify or generate an image to be used as a search key in an image-image search to be subsequently performed by the image search unit 1334. The adjusting unit 1340 presents the generated images to the requesting active user and allows the active user to select at least one generated image from among them. If the active user selects one generated image, the selected generated image is used as a search key. If the active user selects more than one generated image, each of the selected generated images may be used as a search key in an image-image search and the results of the image-image searches may be combined into a single search result. Alternatively, the selected generated images may be combined into a new single image and the new image may be used as a search key.

The adjusting unit 1340 may receive a change made to the search criteria. In this case, a new image is generated based on the changed search criteria and presented to the active user. The adjusting unit 1340 may receive filter criteria. In this case, from among the generated images acquired by the generated image acquiring unit 1332, those that satisfy the filter criteria are extracted and presented to the active user.

The adjusting unit 1340 receives a selection made by the active user who has issued the search request and indicating at least one generated image from among the generated images. Specifically, the adjusting unit 1340 generates a selection request including the generated images acquired by the generated image acquiring unit 1332 and sends it to the requesting user terminal over the network NW. Based on the received selection request, the user terminal generates a generated image display screen and shows the generated screen on the display. The user terminal receives a selection made by the active user and indicating at least one generated image from among the generated images appearing on the generated image display screen. The user terminal generates a selection response including information identifying the selected at least one generated image and sends it to the adjusting unit 1340 over the network NW. Based on the received selection response, the adjusting unit 1340 receives the selection made by the active user and indicating at least one generated image from among the generated images.

The image search unit 1334 performs an image search through the stream DB 1314 and user DB 1318 based on the selected at least one generated image. If the active user selects one generated image, the image search unit 1334 uses the selected generated image as a search key to perform an image-image search through the extracted images in the stream DB 1314 and the profile images and avatar images in the user DB 1318. The result of the image-image search performed by the image search unit 1334 includes sets of an extracted image/profile image/avatar image having a high matching score, a corresponding livestreamer ID, and a stream ID identifying a livestream delivered by the livestreamer identified by the livestreamer ID. The image-image search may be done by the image search unit 1334 using the search technology disclosed in, for example, International Publication No. WO 2018/180201.

If the active user selects more than one generated image, the image search unit 1334 uses each generated image as a search key to perform an image-image search. The image search unit 1334 may combine the results of the searches performed based on the selected generated images to generate a final search result. The results of the searches may be combined through addition, averaging, weighting, or other known techniques.

The providing unit 1336 provides via the network NW the requesting user terminal with the result of the image search done by the image search unit 1334.

The out-of-livestream UI control unit 1402 of the user terminal that has issued the search request generates an image search result display screen based on the received image search result and shows the screen on the display of the user terminal. Once the out-of-livestream UI control unit 1402 receives a livestream selected by the active user via the image search result display screen, the out-of-livestream UI control unit 1402 generates a livestream request including the stream ID of the selected livestream, and transmits the livestream request to the server 1010 over the network NW. The livestreaming information providing unit 1302 starts to provide, to the requesting user terminal, the livestream identified by the stream ID included in the received livestream request. The livestreaming information providing unit 1302 updates the stream DB 1314 such that the user ID of the active user of the requesting user terminal is included in the viewer IDs associated with the stream ID. In this way, the active user can be a viewer of the selected livestream.

The relay unit 1304 relays the video data from the livestreamer-side user terminal 1020 to the viewer-side user terminal 1030 in the livestream started by the livestreaming information providing unit 1302. The relay unit 1304 receives from the viewer-side communication unit 1204 a signal that represents user input by a viewer during the livestream or reproduction of the video data. The signal that represents user input may be an object specifying signal for specifying an object displayed on the display of the user terminal 1030, and the object specifying signal includes the viewer ID of the viewer, the livestreamer ID of the livestreamer of the livestream that the viewer watches, and an object ID that identifies the object. When the object is a gift icon, the object ID is the gift ID. The object specifying signal in that case is a gift use signal indicating that the viewer uses a gift for the livestreamer. Similarly, the relay unit 1304 receives from the livestreamer-side communication unit 1110 of the livestreaming unit 1100 in the user terminal 1020 a signal that represents user input by the livestreamer during reproduction of the video data, such as an object specifying signal.

The gift processing unit 1308 updates the user DB 1318 so as to increase the reward for the livestreamer depending on the reward to be awarded of the gift identified by the gift ID included in the gift use signal. Specifically, the gift processing unit 1308 refers to the gift DB 1320 to specify a reward to be awarded for the gift ID included in the received gift use signal. The gift processing unit 1308 then updates the user DB 1318 to add the specified reward to be awarded to the reward for the livestreamer ID included in the gift use signal.

The payment processing unit 1310 processes payment of a price of the gift by the viewer in response to reception of the gift use signal. Specifically, the payment processing unit 1310 refers to the gift DB 1320 to specify the price points of the gift identified by the gift ID included in the gift use signal. The payment processing unit 1310 then updates the user DB 1318 to subtract the specified price points from the points of the viewer identified by the viewer ID included in the gift use signal.

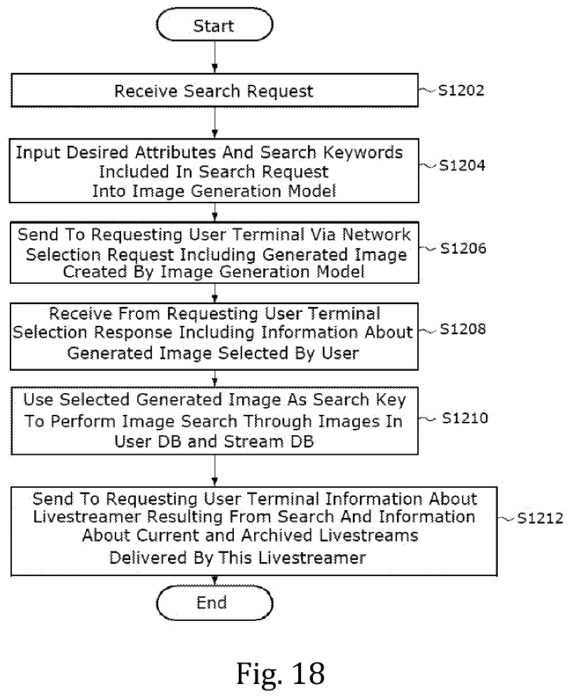

The operation of the livestreaming system 1001 with the above configuration will be now described. FIG. 18 is a flowchart showing a series of steps related to a search for a livestreamer performed by the server 1010. The server 1010 receives a search request from a user terminal over the network NW (S1202). The server 1010 inputs the desired attributes and search keywords included in the received search request into the image generation model 1338 (S1204). The server 1010 transmits a selection request including the generated images generated by the image generation model 1338 to the requesting user terminal over the network NW (S1206). The server 1010 receives from the requesting user terminal a selection response including the information about the generated image selected by the user (S1208). The server 1010 uses the selected generated image as a search key to perform an image search through the images held in the user DB 1318 and the images held in the stream DB 1314 (S1210). The server 1010 sends to the requesting user terminal the information about the livestreamer resulting from the search and the information about the current and archived livestreams delivered by the livestreamer (S1212).

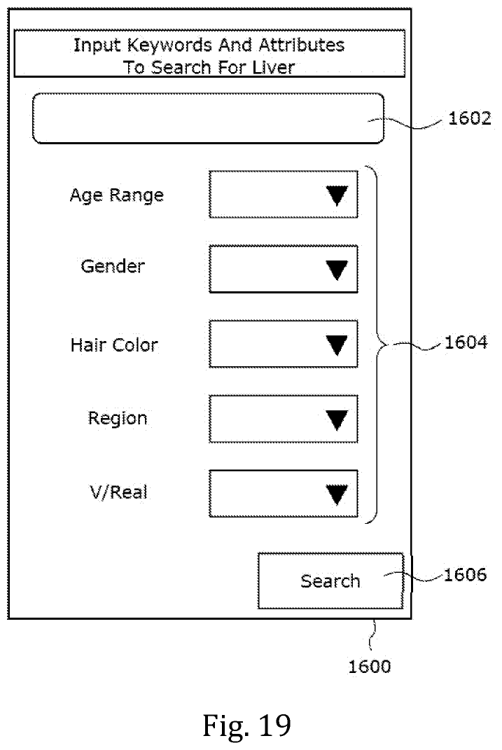

FIG. 19 is a representative screen image of a search criteria receiving screen 1600 displayed on the display of the active user's user terminal. The search criteria receiving screen 1600 allows the active user to input search criteria. The search criteria receiving screen 1600 has a keyword input area 1602 for allowing the active user to input search keywords in any text format, an attribute designating area 1604 for allowing the active user to designate an attribute in a pull-down format, and a search button 1606.

The active user enters desired search keywords in the keyword input area 1602, selects a desired attribute in the attribute designating area 1604, and presses the search button 1606. On detection of the search button 1606 being pressed, the out-of-livestream communication unit 1404 of the user terminal generates a search request including the search keywords entered in the keyword input area 1602, the attribute selected in the attribute designating area 1604, and the user ID of the active user, and sends it to the server 1010 over the network NW.

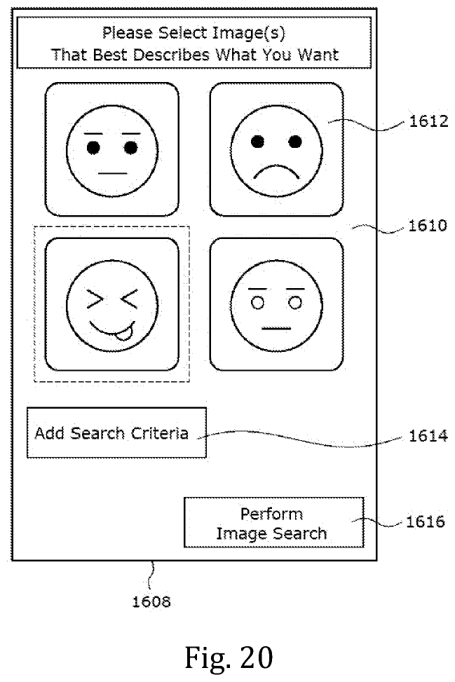

FIG. 20 is a representative screen image of a generated image display screen 1608 displayed on the display of the active user's user terminal. The generated image display screen 1608 includes a plurality of generated images generated by inputting the search criteria (search keywords and attributes) entered via the search criteria receiving screen 1600 in FIG. 19 into the image generation model 1338. The generated image display screen 1608 has a generated image display area 1610 showing a plurality of generated images 1612 included in the selection request received from the server 1010 in response to the search request, a search criteria add button 1614, and an image search execution button 1616.

The active user may tap the search criteria add button 1614. In this case, the out-of-livestream UI control unit 1402 provides an interface to allow the active user to add or update the search criteria in order to generate generated images again. The user terminal receives via the interface an update request for generated images. Alternatively, the out-of-livestream UI control unit 1402 provides an interface to allow the active user to add search criteria and narrow down the search results.

The active user selects or designates one or more of the generated images displayed in the generated image display area 1610 that well reflect the type of livestreamer the active user looks for, and presses the image search execution button 1616. On detection of the image search execution button 1616 being pressed, the out-of-livestream UI control unit 1402 receives the selection or designation representing at least one generated image from among the generated images on the generated image display screen 1608. The out-of-livestream communication unit 1404 generates a selection response including information identifying the generated image selected or designated in the generated image display area 1610 and sends it to the server 1010 over the network NW.

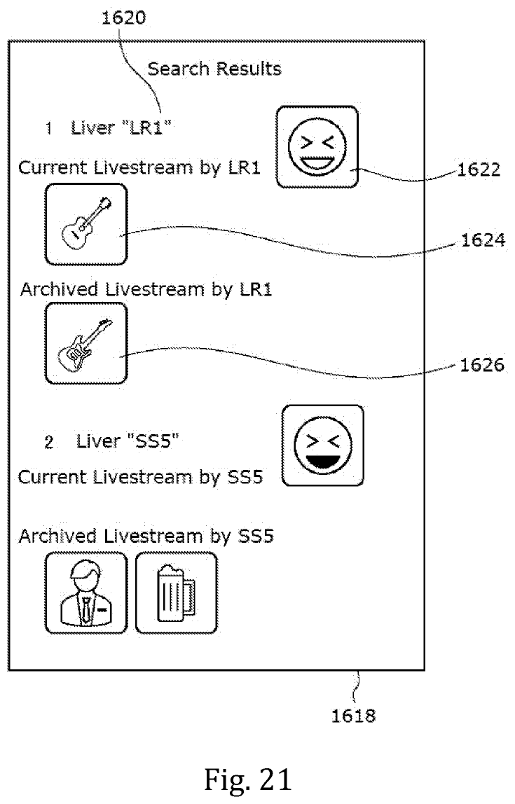

FIG. 21 is a representative screen image of an image search result display screen 1618 displayed on the display of the active user's user terminal. The image search result display screen 1618 includes the results of the image search performed in response to the selection of the generated image via the generated image display screen 1608 in FIG. 20. The out-of-livestream communication unit 1404 receives from the server 1010 the results of the image search performed in response to the selection response transmitted via the generated image display screen 1608 in FIG. 20. The out-of-livestream UI control unit 1402 generates an image search result display screen 1618 based on the received image search results and shows the screen on the display. The image search result display screen 1618 includes a livestreamer ID 1620 included in the image search results, a profile image 1622 of the livestreamer identified by the livestreamer ID, a thumbnail 1624 representing a livestream currently delivered by the livestreamer identified by the livestreamer ID, and a thumbnail 1626 representing an archived livestream delivered in the past by the livestreamer.

In the above embodiment, an example of a holding unit includes a hard disk or semiconductor memory. It is understood by those skilled in the art that each element or component can be realized by a CPU not shown, a module of an installed application program, a module of a system program, or a semiconductor memory that temporarily stores the contents of data read from a hard disk, and the like.

According to the livestreaming system 1001 relating to the present embodiment, images generated based on texts are used. In this way, text-to-image searches can be performed to find desired livestreamers without requiring tagging of images. This can reduce the workload of the user and administrator. Although the images may be updated frequently, for example, in a case where images are extracted from livestreams, searches can still return accurate results as in the conventional art or more accurate results than in the conventional art.

In the livestreaming system 1001 relating to the present embodiment, a plurality of different generated images are generated based on search criteria and presented to the user as options. The user can designate one or more of the generated images that fit his/her desire better. Thus, the search for livestreamers can return more reliable results. For example, a single text may mean different ideas between different cultures, but the present embodiment can take care of such differences. For example, a Japanese text “kawaii (cute)” may mean different ideas than a corresponding text in a different country. According to the present embodiment, a generated image reflecting what is meant by the Japanese text “kawaii” and a generated image reflecting what is meant by a corresponding text in a different country are both presented to the user. The difference in meaning may result in disappointing search results. The present invention can prevent or reduce such disappointment.

In the conventional art, searches are performed based on tags attached to images. If search keywords do not match any of the tags, the searches often return no results. In the livestreaming system 1001 relating to the present embodiment, on the other hand, the machine learning models may generate generated images based on search criteria, and image searches are performed using the generated images as a search key. Therefore, some search results can be always returned for any search criteria. No search results may lower user satisfaction, but the present invention can avoid such problems.

In the livestreaming system 1001 relating to the present embodiment, the generated images and one or more selected generated images can be acquired as data and used effectively. For example, such data can be used in analyzing currently popular faces.

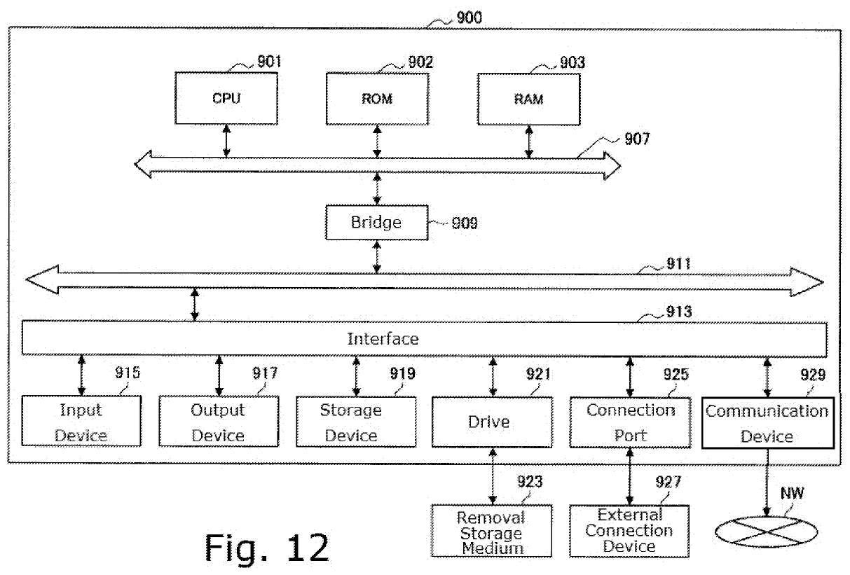

Referring to FIG. 12, the hardware configuration of an information processing device according to the first and second embodiments will be now described. FIG. 12 is a block diagram showing an example of a hardware configuration of an information processing device according to the first and second embodiments. The illustrated information processing device 900 may, for example, realize the server 10 and the user terminals 20 and 30 in the first embodiment and the server 1010 and the user terminals 1020 and 1030 in the second embodiment.

The information processing device 900 includes a CPU 901, ROM (Read Only Memory) 902, and RAM (Random Access Memory) 903. The information processing device 900 may also include a host bus 907, a bridge 909, an external bus 911, an interface 913, an input device 915, an output device 917, a storage device 919, a drive 921, a connection port 925, and a communication device 929. In addition, the information processing device 900 includes an image capturing device such as a camera (not shown). The CPU 901 is an example of hardware configuration to realize various functions performed by the components described herein. The functions described herein may be realized by circuitry programmed to realize such functions described herein. The circuitry programmed to realize such functions described herein includes a central processing unit (CPU), a digital signal processor (DSP), a general-use processor, a dedicated processor, an integrated circuit, application specific integrated circuits (ASICs) and/or combinations thereof. Various units described herein as being configured to realize specific functions, including but not limited to the livestreaming unit 100, a viewing unit 200, the out-of-livestream processing unit 400, the image capturing control unit 102, the audio control unit 104, the video transmission unit 106, the livestreamer-side UI control unit 108, the viewer-side UI control unit 202, the viewer-side communication unit 204, the stream DB 314, the user DB 318, the introduction DB 328, the search request receiving unit 330, the search unit 334, the providing unit 336, the converting unit 338, the out-of-livestream UI control unit 402, and the out-of-livestream communication unit 404, may be embodied as circuitry programmed to realize such functions.

The CPU 901 functions as an arithmetic processing device and a control device, and controls all or some of the operations in the information processing device 900 according to various programs stored in the ROM 902, the RAM 903, the storage device 919, or a removable recording medium 923. For example, the CPU 901 controls the overall operation of each functional unit included in the server 10 and the user terminals 20 and 30 in the first embodiment and the server 1010 and the user terminals 1020 and 1030 in the second embodiment. The ROM 902 stores programs including sets of instructions, calculation parameters, and the like used by the CPU 901. The RAM 903 serves as a primary storage that stores programs including sets of instructions to be used in the execution of the CPU 901, parameters that appropriately change in the execution, and the like. The CPU 901, ROM 902, and

RAM 903 are interconnected to each other by the host bus 907 which may be an internal bus such as a CPU bus. Further, the host bus 907 is connected to the external bus 911 such as a PCI (Peripheral Component Interconnect/Interface) bus via the bridge 909.

The input device 915 may be a user-operated device such as a mouse, keyboard, touch panel, buttons, switches and levers, or a device that converts a physical quantity into an electric signal such as a sound sensor typified by a microphone, an acceleration sensor, a tilt sensor, an infrared sensor, a depth sensor, a temperature sensor, a humidity sensor, and the like. The input device 915 may be, for example, a remote control device utilizing infrared rays or other radio waves, or an external connection device 927 such as a mobile phone compatible with the operation of the information processing device 900. The input device 915 includes an input control circuit that generates an input signal based on the information inputted by the user or the detected physical quantity and outputs the input signal to the CPU 901. By operating the input device 915, the user inputs various data and instructs operations to the information processing device 900.

The output device 917 is a device capable of visually or audibly informing the user of the obtained information. The output device 917 may be, for example, a display such as an LCD, PDP, or OELD, etc., a sound output device such as a speaker and headphones, and a printer. The output device 917 outputs the results of processing by the information processing device 900 as text, video such as images, or sound such as audio.

The storage device 919 is a device for storing data configured as an example of a storage unit of the information processing device 900. The storage device 919 is, for example, a magnetic storage device such as a hard disk drive (HDD), a semiconductor storage device, an optical storage device, or an optical magnetic storage device. This storage device 919 stores programs executed by the CPU 901, various data, and various data obtained from external sources.

The drive 921 is a reader/writer for the removable recording medium 923 such as a magnetic disk, an optical disk, a photomagnetic disk, or a semiconductor memory, and is built in or externally attached to the information processing device 900. The drive 921 reads information recorded in the mounted removable recording medium 923 and outputs it to the RAM 903. Further, the drive 921 writes record in the attached removable recording medium 923.

The connection port 925 is a port for directly connecting a device to the information processing device 900. The connection port 925 may be, for example, a USB (Universal Serial Bus) port, an IEEE1394 port, an SCSI (Small Computer System Interface) port, or the like. Further, the connection port 925 may be an RS-232C port, an optical audio terminal, an HDMI (registered trademark) (High-Definition Multimedia Interface) port, or the like. By connecting the external connection device 927 to the connection port 925, various data can be exchanged between the information processing device 900 and the external connection device 927.

The communication device 929 is, for example, a communication interface formed of a communication device for connecting to the network NW. The communication device 929 may be, for example, a communication card for a wired or wireless LAN (Local Area Network), Bluetooth (trademark), or WUSB (Wireless USB). Further, the communication device 929 may be a router for optical communication, a router for ADSL (Asymmetric Digital Subscriber Line), a modem for various communications, or the like. The communication device 929 transmits and receives signals and the like over the Internet or to and from other communication devices using a predetermined protocol such as TCP/IP. The communication network NW connected to the communication device 929 is a network connected by wire or wirelessly, and is, for example, the Internet, home LAN, infrared communication, radio wave communication, satellite communication, or the like. The communication device 929 realizes a function as a communication unit.

The image capturing device (not shown) is, for example, a camera for capturing an image of the real space to generate the captured image. The image capturing device uses an imaging element such as a CCD (Charge Coupled Device) or CMOS (Complementary Metal Oxide Semiconductor) and various elements such as lenses that are provided to control image formation of a subject on the imaging element. The image capturing device may capture a still image or may capture a moving image.

The configuration and operation of the livestreaming systems 1 and 1001 in the first and second embodiments have been described. These embodiments are merely an example, and it will be understood by those skilled in the art that various modifications are possible by combining the respective components and processes, and that such modifications are also within the scope of the present disclosure.

The first and second embodiments are described with reference to a live streaming platform, but the present invention is not limited to such. The technical concepts of the embodiments can be applied to other video livestreaming platforms such as VOD (Video On Demand).

In the first embodiment, the search text generation mode 332 is configured with one of the personalities with which the respective introduction generation models are configured, but the present embodiment is not limited to such. For example, the search text generation model may be configured with a personality that is not included in the personalities with which the introduction generation models are configured or may not be configured with any personality.

In the first embodiment, the introduction generation models may generate additional information to supplement the introductions. An example of the additional information is as follows.

“List of related songs and introductions

XX (artist name)

“ABCDE” is a country-pop song with a catchy melody and a composition based on music theory. The chorus section has a chord progression of G, D, Em, and C, which makes the listener feel stable and exultant.

The song “HHKKLL” is a pop tune with elements of funk and R&B. As for the composition, the I-V-vi-IV chord progression is used extensively, which leaves a strong impression on the listener.

The song “PPQQQ” has a pop tune, but also incorporates modern elements such as synthesizer sounds and beatboxing. As for the composition, the I-V-vi-IV chord progression is used extensively, creating a pleasant impression on the listener.

These are just a few of the songs that XX has created using music theory. Her songs are not only pleasant and memorable to listen to, but also packed with interesting elements from the perspective of musical theory”

““CCDDE” This song is famous for the variety of chord progressions and music theory elements incorporated in the guitar riffs and solos.

“FFG” This piece features a guitar solo with complex harmony and scales, often used as an example of applied music theory.

“HKLL” This song, with its melodic intro and guitar solo, is sometimes used to illustrate harmony theory and melodic structure.”

“List for Beginners:
“TT”
. . .

List for Others:
“ZA””

In the first embodiment, the information about the user may include the information published on external platforms such as SNS.

According to the first embodiment, a search keyword is designated and a search request is accordingly generated. The first embodiment, however, is not limited to such. The technical concept of the first embodiment can be applied to, for example, recommend livestreamers to the users.

According to the second embodiment, livestreamers are searched for. The second embodiment, however, is not limited to such. The technical ideas of the second embodiment can also be applied to searches for current and archived livestreams.

According to the second embodiment, the user is presented with a plurality of generated images and allowed to select one or more of them. The second embodiment, however, is not limited to such. For example, the user may be presented with one generated image and asked if he/she would like to select it or change the search criteria. Alternatively, once completed, the generated images may be used as a search key to perform an image search without asking the user.

According to the second embodiment, the attributes designated by the user as the search criteria are input into the image generation model 1338. The second embodiment, however, is not limited to such. For example, instead of or in addition to being input into the image generation model 1338, the attributes designated by the user as the search criteria may be used to narrow down in advance the livestreamers in the user DB 1318. For example, if a virtual livestreamer is designated as the search criteria, the server may extract, from the images held in the user DB 1318, the images of the livestreamers having their V-real flag set to virtual, and treat the extracted images as a population for an image search.

According to the second embodiment, the search request includes search keywords and attributes. The second embodiment, however, is not limited to such. The search request may include either search keywords or attributes. Alternatively, the search request may include images, audio, and the profile information and viewing history of the requesting user.

According to the second embodiment, the user terminal of the active user generates a search request. The second embodiment, however, is not limited to such. The technical concept of the second embodiment can be applied to, for example, to recommend livestreamers to the user. In this case, the search request may include the profile information and viewing history of the user. The viewing history may include the profile images of the livestreamers of the livestreams the user has viewed in the past. Since these profile images are input into the image generation models, the generated images are highly likely to match the user's preference.

The return rate of the gift, which indicates the ratio of the reward to be awarded to the price points in the first and second embodiments is merely an example, and the return rate may be appropriately set by the administrator of the live-streaming system, for example.

The technical ideas according to the first and second embodiments may be applied to livestream shopping or virtual livestreaming using an avatar that moves in synchronization with the movement of the livestreamer instead of the image of the livestreamer. The second embodiment can be used as follows, for example. The user may input a text, images of products the user wants may be generated based on the input text, and the generated images may be used as a search key to search through the images of the products available in livestream shopping, or through the images extracted from the videos of livestream shopping. For example, the user may enter the words “green, clothing.” The system may generate a plurality of images showing green clothing and present them to the user. The user then may select one or more of the generated images that match his or her taste, and the system may perform an image search using the green clothing included in the selected generated images as a search key. The results of the search may include product images of clothing similar in color and style to the clothing used as the search key, or livestreams delivered by the livestreamers wearing clothing similar to the clothing used as the search key.

The technical ideas relating to the first embodiment may be represented by the following items.

### <Item 1>

A server including a circuitry, wherein the circuitry is configured to:
hold, in a livestreamer information holding unit, information about a livestreamer distributing a video on a video livestreaming platform;
hold, in a video data holding unit, video data including images and sounds of the video distributed by the livestreamer;
convert, in a converting unit, the video data held in the video data holding unit into text data;
use a plurality of machine learning models each of which is designed to receive the text data and the information about the livestreamer held in the livestreamer information holding unit and output a sentence introducing the livestreamer, the machine learning models being configured respectively with different personalities;
hold, in a sentence holding unit, an ID identifying the livestreamer and a plurality of sentences introducing the livestreamer output from the machine learning models, in association with each other;
receive, in a request receiving unit, a search request from a user terminal of a user of the video livestreaming platform over a network;
perform, in a search unit, a search through the sentence holding unit based on the search request; and
provide, in a providing unit, via the network the user terminal with a result of the search performed by the search unit.

### <Item 2>

The server of item 1, wherein the circuitry is further configured to:
use another machine learning model for receiving information about the user of the user terminal and a keyword representing a search target included in the search request and outputting a sentence representing a desire of the user,
wherein the search unit performs a search by comparing the sentence output from the another machine learning model against the sentences held in the sentence holding unit.

### <Item 3>

The server of item 2, wherein the another machine learning model is configured with the same personality as one of the machine learning models.

### <Item 4>

The server of item 1, wherein the video distributed on the video livestreaming platform is distributed by the livestreamer in real time.

The technical ideas relating to the second embodiment may be represented by the following items.

### <Item 1>

A server including a circuitry, wherein the circuitry is configured to:
hold, in an image holding unit, images related to a video distributed on a video livestreaming platform;
receive, in a request receiving unit, a search request from a user terminal of a user of the video livestreaming platform over a network;
acquire, in a generated image acquiring unit, a generated image generated by a machine learning model based on information input into the machine learning model, the information being input by the user and included in the search request;
perform, in a search unit, an image search through the image holding unit based on the generated image; and
provide, in a providing unit, via the network the user terminal with a result of the image search performed by the search unit.

### <Item 2>

The server of item 1,
wherein the generated image acquiring unit acquires a plurality of generated images generated by the machine learning model based on the information input by the user and included in the search request,
wherein the server further includes a selection receiving unit for receiving a selection made by the user and indicating at least one generated image from among the generated images, and
wherein the search unit performs an image search through the image holding unit based on the at least one generated image indicated by the selection.

### <Item 3>

The server of item 1,
wherein the information input by the user and included in the search request includes a text and an attribute, and
wherein the machine learning model generates a generated image that corresponds to the text and matches the attribute.

### <Item 4>

The server of item 1,
wherein the video distributed on the video livestreaming platform is distributed in real time by a livestreamer, and
wherein the image holding unit holds an image generated from the video while the video is being distributed.

### <Item 5>

A computer program for causing a terminal to perform functions of:
displaying on a display a search criteria receiving screen for enabling an input of search criteria;
displaying on the display a generated image display screen including a plurality of generated images generated by a machine learning model based on the search criteria input thereto, the search criteria being input via the search criteria receiving screen;
receiving a selection on the generated image display screen, the selection indicating at least one generated image from among the generated images; and
displaying on the display an image search result display screen including a result of an image search corresponding to the selection.

The procedures described herein, particularly those described with a flow diagram or a flowchart, are susceptible of omission of part of the steps constituting the procedure, adding steps not explicitly included in the steps constituting the procedure, and/or reordering the steps. The procedure subjected to such omission, addition, or reordering is also included in the scope of the present disclosure unless diverged from the purport of the present invention.

At least some of the functions realized by the server may be realized by a device(s) other than the server, for example, the user terminals. At least some of the functions realized by the user terminals may be realized by a device(s) other than the user terminals, for example, the server. For example, the superimposition of a predetermined frame image on an image of the video data performed by the viewer's user terminal may be performed by the server or may be performed by the livestreamer's user terminal.

What is claimed is:

1. A server comprising a circuitry, wherein the circuitry is configured to:
hold, in a livestreamer information holding unit, information about a livestreamer distributing a video on a video livestreaming platform;
hold, in a video data holding unit, video data including images and audio of the video distributed by the livestreamer;
convert, in a converting unit, the video data held in the video data holding unit into text data; and
use a plurality of machine learning models each of which is designed to receive the text data and the information about the livestreamer held in the livestreamer information holding unit and output a sentence introducing the livestreamer, the machine learning models being respectively configured with different personalities.

2. The server of claim 1, wherein the circuitry is further configured to:
hold, in a sentence holding unit, an ID identifying the livestreamer, a plurality of sentences introducing the livestreamer, and output from the machine learning models, in association with each other.

3. The server of claim 2, wherein the circuitry is further configured to:
receive, in a request receiving unit, a search request via a network from a user terminal of a user of the video livestreaming platform; and
perform, in a search unit, a search through the sentence holding unit based on the search request.

4. The server of claim 3, wherein the circuitry is further configured to:
provide, in a providing unit, via the network the user terminal with a result of the search performed by the search unit.

5. The server of claim 3, wherein the circuitry is further configured to:
use another machine learning model for receiving information about the user of the user terminal and a keyword indicating a search target included in the search request and outputting a sentence representing a desire of the user,
wherein the search unit performs the search by comparing the sentence output from the another machine learning model and the sentences held in the sentence holding unit.

6. The server of claim 5, wherein the another machine learning model is configured with the same personality as one of the machine learning models.

7. The server of claim 1, wherein the video distributed on the video livestreaming platform is distributed by the livestreamer in real time.

8. A method comprising:
holding, in a livestreamer information holding unit, information about a livestreamer distributing a video on a video livestreaming platform;
holding, in a video data holding unit, video data including images and audio of the video distributed by the livestreamer;
converting the video data held in the video data holding unit into text data; and
inputting the text data and the information about the livestreamer held in the livestreamer information holding unit into a plurality of machine learning models to cause each of the machine learning models to output a sentence introducing the livestreamer, the machine learning models being respectively configured with different personalities.

9. The method of claim 8, further comprising
holding, in a sentence holding unit, an ID identifying the livestreamer, a plurality of sentences introducing the livestreamer, and output from the machine learning models, in association with each other.

10. The method of claim 9, further comprising:
receiving, in a request receiving unit, a search request via a network from a user terminal of a user of the video livestreaming platform; and
performing, in a search unit, a search through the sentence holding unit based on the search request.

11. The method of claim 10, further comprising
providing, in a providing unit, via the network the user terminal with a result of the search performed.

12. The method of claim 10, further comprising
inputting information about the user of the user terminal and a keyword indicating a search target included in the search request into another machine learning model to cause the other machine learning model to output a sentence representing a desire of the user,
wherein the search is performed by comparing the sentence output from the another machine learning model and the sentences held in the sentence holding unit.

13. The method of claim 12, wherein the another machine learning model is configured with the same personality as one of the machine learning models.

14. The method of claim 8, wherein the video distributed on the video livestreaming platform is distributed by the livestreamer in real time.
